(19) United States
(12) Patent Application Publication
(10) Pub. No.: US 2026/0296942 A1
(43) Pub. Date: Oct. 1, 2026

(54) PROCESS AND SYSTEM FOR DEGRADING A CHEMICAL COMPOUND IN A LIQUID STREAM

(71) Applicant: AQUASOIL S.R.L., Fasano, Brindisi (IT)

(72) Inventors: Mao TIE, Fasano (IT); Santoro ORONZO, Fasano (IT)

(73) Assignee: AQUASOIL S.R.L., Fasano, Brindisi (IT)

(21) Appl. No.: 19/489,868

(22) PCT Filed: May 22, 2024
(86) PCT No.: PCT/IT2024/050102

§ 371 Date: Dec. 3, 2025

(30) Foreign Application Priority Data
Jun. 6, 2023 (IT) 102023000011451

(51) Int. Cl. C02F 9/00; C02F 1/00; C02F 1/32; C02F 1/68; C02F 1/72; C02F 1/78; C02F 101/16; C02F 101/30; C02F 101/34

(52) U.S. Cl. CPC C02F 9/00; C02F 1/001; C02F 1/325; C02F 1/685; C02F 1/725; C02F 1/78; C02F 2101/166; C02F 2101/308; C02F 2101/34; C02F 2201/004; C02F 2201/005; C02F 2201/007; C02F 2201/784; C02F 2209/001; C02F 2209/006; C02F 2209/03; C02F 2209/40

(57) ABSTRACT

A process and a related system facilitate the degradation of a chemical compound in a liquid stream. A pump is fluidically connected in series with a treatment chamber having a mixer, and a reagent injector between the pump and the treatment chamber. The liquid stream is introduced to an inlet of the pump that directs the liquid stream to an inlet of the treatment chamber, producing a pressure increase between the pump inlet and the treatment chamber of from 0.1 to 10 bars. A degradation reagent is introduced into the liquid stream through the injector at a pressure greater than or equal to the pressure between the pump inlet and the treatment chamber. The degradation reagent is mixed by the mixer in the liquid stream at a mixing intensity in a range of from 0.7 W/L to 700 W/L to intentionally create conditions that enhance production of reactive species.

### FIELD

The present invention relates to a process and a system for degrading a chemical compound in a liquid stream. In particular, the present invention relates to the treatment of a liquid stream to degrade undesired chemical compounds in the liquid stream.

### BACKGROUND

Ozone bubble reactors and venturi injection systems are the two major classes for ozonation systems found in the state of the art. Ozone bubble reactors involve injecting ozone gas into a liquid, creating bubbles that interact with the liquid. These bubbles transfer ozone into the liquid through diffusion. The efficiency of ozone transfer depends on factors such as bubble size, contactor height, residence time, and ozone concentration difference between the bubble and the liquid. However, these reactors often face severe limitations in mass transfer efficiency which results in high capital cost requirements for the construction of ozonation column systems, and high operational costs. Indeed, larger bubbles rise quickly to the surface, progressively decreasing their pressure and reducing their contact time with the liquid. Additionally, the bubbles tend to coalesce and promote reactions only in their immediate vicinity, rather than throughout the entire liquid. The venturi injection system is an apparatus that utilizes a specially designed pipe called a venturi tube. When a fluid passes through this tube's narrow section, it accelerates, leading to a pressure drop. In venturi ozone injection, ozone gas is introduced at the narrow section, and the pressure drop causes the gas to be drawn into the flowing liquid, leading to ozone dissolution. The efficiency of venturi injection is also rather limited, and depends on factors such as pressure difference, gas and liquid flow rates, and the geometry of the venturi tube. However, this system also has severe limitations. Indeed, the maximum pressure differential generated by the apparatus is limited by the absolute vacuum pressure. Additionally, as pressure decreases, gas solubility decreases, further limiting mass transfer efficiency. Moreover, the gas is typically released as relatively large bubbles, similar in size to the venturi injector tip size. Being introduced into a low-pressure environment these bubbles tend to expand due to the lower pressure in the fluid caused by the venturi effect. These conditions severely restrict mass transfer and ozone reactivity. Furthermore, the flow restriction imposed by the venturi apparatus limits the mainline application to this technology to very low flow, due to the head losses introduced by the system itself. Another type of solution available in the state of the art is to use the venturi injection system in a side stream configuration. However, this solution is severely limited in efficiency since most hydroxyl radicals are formed in the side stream and cannot be transported in the fluid due to their very short lifetime in the order of nanoseconds. As a result, they are wasted in the side stream instead of being used to attack and degrade the contaminant in the mainstream.

Some devices for dosing and mixing reagents in liquid flows are known at the state of the art. For example, International Patent Publication WO 2016/194009 describes a device configured in such a way that solid, liquid and gaseous reagents can be dosed in various doses and combinations immediately upstream of an impeller of a circulation pump and, in particular, at a distance of less than twice the diameter of the intake duct. Although useful to favor dispersion of the reagents in the liquid stream to be treated, which takes place in the impeller of the pump, the quantities of injectable gaseous reagents are still very limited due to blocking of the flow by the gas (gas locking) in the impeller. Consequently, the device described in WO 2016/194009 often requires the injection of more of the gaseous reagents downstream of the system to ensure completion of degradation reactions thus also needing additional contact time to complete the degradation of the target pollutant.

Italian published patent application No. 102018000007374 describes a device for dosing reagents in a liquid flow comprising two pumps connected in series and a flange equipped with a device for dosing gaseous reagents within the liquid flow connected to the delivery pipe of the first pump. The hydraulic circuit is configured so that the delivery of the first pump is directly linked to this flange, which in turn is directly connected to the suction of the second pump mentioned above. This device overcomes certain limits in the use of gaseous reagents highlighted for WO 2016/194009 allowing a significant increase in the dosage of gaseous reagents ensuring a certain stability of the system. However, this device suffers from being unable to complete the reaction prior to the liquid stream exiting the device. As a result, additional contact time is required downstream of the device. Moreover, the treatment time required for the complete treatment of the pollutants could not be controlled by increasing gaseous reagent concentrations due to gas locking associated with operating the system at fixed speed and fixed volume (hence fixed mixing intensity). Moreover, role of the possible disequilibrium conditions enhancing mass transfer associated was not recognized. Finally, this device focused on mass transfer under equilibrium conditions without consideration of yields of pollutant degradation.

WO-A1-98/24728 discloses a process which teaches away from the process of the present invention, in that it suggests keeping the physical conditions set at the inlet and therefore does not recognize the chance of incrementing the inlet pressure in the treatment device. Moreover, it is not recognized to intentionally create physical conditions of disequilibrium and unsteadiness in the system by increasing and decreasing, in space and time, the physical-chemical conditions of the process (for example, increase/decrease of pressure, velocity gradients and mixing intensity). These physical conditions of disequilibrium and unsteadiness, disclosed in the present invention, allows a substantial increase in mass transfer and processing rates. Moreover, WO-A1-98/24728 discloses a solution which is limited in pressure and mixing intensity since the maximum applicable pressure in the treatment zone cannot exceed the inlet pressure, and the maximum mixing intensity in the same treatment zone cannot exceed the overall head available (that is, the difference between inlet pressure and atmospheric pressure). In view of this limitation, WO-A1-98/24728 teaches in the direction of maintaining the conditions established at the inlet, without ever considering the possibility of increasing pressure and mixing intensity or optimally manage their variation with the purpose of intensifying the contaminant degradation process.

WO-A2-2008052143 teaches away from the present invention in that the use of separation baffles between rotor and stator is disclosed: these baffles are designed to keep separate the fluids for most of their residence time in the device, to then uniformly and quickly dispense them in the mixing area. The present invention, instead, maximizes the reaction and treatment volume, enabling and optimizing the mixing mechanisms simultaneously with the reaction mechanisms (instead of operating them in a segregate and sequential way as in WO-A2-2008052143). In addition, no reference is made to the need of controlling pressure or mixing intensity as independent variables, although correlated when the overall objective of contaminant treatment via a plurality of degradation mechanisms is concerned (as disclosed in the present invention). From the chemical point of view, WO-A2-2008052143 teaches away from the present invention in that the amount of hydrogen peroxide is limited. As a matter of fact, the maximum allowable concentration reported in WO-A2-2008052143 is indicated in the amount of 1 mg/L (1 ppm). On the contrary, such quantity represents a very low value for the applications disclosed in the present invention. Indeed, the present invention discloses efficient oxidating and reducing processes which require the use of oxidizing and/or reducing substances almost always at concentrations greater than 1 mg/L (1 ppm). Finally, the object of WO-A2-2008052143 is not to achieve nearly complete treatment with high reaction yields within the same disclosed device but rather to achieve efficient mixing among substances (with no reference to treatment). On the contrary, WO-A2-2008052143 discloses the transfer of mixed fluids and substances in an upstream device (bioreactor) where reaction functions and treatment are performed. In other words, the bio-chemical transformations occur ex situ in WO-A2-2008052143, contrarily to the present invention where they occur in situ.

Despite the state of the art, further improvements are needed to the dissolution of degradation reagents and to the degradation of undesired chemical compounds in the liquid flow.

### SUMMARY

The present invention provides for a process for the degradation of a chemical compound in a liquid stream comprising the steps of: providing a pump fluidically connected in series with a treatment chamber comprising a mixer, and a reagent injector between the pump and the treatment chamber; introducing the liquid stream to an inlet of the pump; operating the pump to direct the liquid stream to an inlet of the treatment chamber to produce a pressure increase between the pump inlet and the treatment chamber of from 0.1 bar to 10 bar; introducing a degradation reagent into the liquid stream through the injector at a pressure greater than or equal to the pressure between the pump and the treatment chamber; and, operating the mixer to mix the degradation reagent in the liquid stream at a mixing intensity (namely a mixing power input per volume, wherein the mixing power input is the power of the mixer and the volume is the volume of the treatment chamber) in a range of from 0.7 W/L to 700 W/L to intentionally create physical and chemical conditions required to simultaneously enhance the mass transfer and the degradation of one or more contaminants present in the liquid stream.

The process provides for a high mass transfer efficiency of a gaseous degradation reagent into the liquid stream. In addition, for gaseous degradation reagents, the system can operate with high gaseous partial pressure because of the possibility of a direct injection into the liquid of a gaseous stream being characterized by high concentration of the gaseous reagent under high pressure. As a result, a lower Concentration*Time (CT) dose is required for the degradation reagent while providing improved reaction efficiency for optimizing removal of a variety of different chemical compounds from the liquid stream through oxidative pathways, reductive pathways, or a combination thereof.

It has been found that control of mixing intensity is most important for obtaining optimal dissolution of degradation reagents, especially gaseous degradation reagents, in the liquid stream. The mixer not only mixes the degradation reagent but also the reaction products ensuring that the reaction does not become diffusion limited from the reaction products side. In addition, higher mixing intensity favors the formation of highly reactive species allowing the process to work under kinetic controlled conditions rather than mass transfer limited conditions. This is because the formation of such highly reactive oxidizing and reducing species are the result of the reactions and decomposition mechanisms associated with the radical chemistry of the dissolved degradation reagents used in the process. Mass injection rate of the degradation reagent into the liquid stream is also an important factor as, together with the liquid flow rate, the maximum theoretical dissolved concentration ever achievable by the process (attainable by dividing mass injection rate by the liquid flow rate). Further synergies in accelerating chemical reactions and producing secondary reactive species (defined herein as oxidizing and reducing secondary reagents able to degrade a contaminant present in the fluid stream which are formed upon injecting the one or more primary reagents in the treatment chamber operated at mixing intensity >0.7 W/L and pressure >0.1 bar above atmospheric pressure) are realized in controlling centrifugal mixing speed in view of pressure in the treatment chamber; when controlling degradation reagent mass injection rate in view of residence time in the treatment chamber, and when controlling residence time in view of pressure in the treatment chamber.

Furthermore, when combinations of inter-reactive degradation reagents, for example ozone and hydrogen peroxide, are utilized, control of mixing intensity is also most important for establishing a high reaction efficiency. Mass injection rate of the degradation reagent into the liquid stream is also an important factor. While residence time alone is not a significant factor, residence time becomes very significant if considered in combination with mixing intensity and mass injection rate.

The process described herein may be utilized to degrade unwanted chemical or biological compounds (i.e., pollutants). The degradation can be done in a primary liquid stream as well as for the formation, in a secondary side-stream or in-situ, of secondary species able, upon injection in the primary liquid stream, to degrade unwanted chemical compounds in a primary liquid stream. The liquid stream may be aqueous or non-aqueous. The liquid stream may be a primary liquid stream or a secondary liquid stream. In a treatment system, the process may be applied to one or more of the liquid streams. Water streams, with and without particulate matter, are of particular note. Some examples of liquid streams that can be treated in the process are groundwater, rainwater, runoff water, surface water, brackish water, seawater, diluted slurries, drinking water, municipal wastewater, industrial wastewater and process water (e.g., industrial water used in production processes) and the like.

The process utilizes a pressure increase zone fluidically connected in series with a high intensity mixing zone with a degradation reagent injection zone situated between the pressure increase zone and the mixing zone. The fluid moving device may comprise a pump or any other device that can move the liquid stream under pressure. Some examples of fluid moving devices are linear mixers, rotating mixers, agitators, paddle mixers and pump flow mixers. In some embodiments, the fluid moving device comprises an impeller, for example a powered rotating impeller. The impeller may rotate in a direction that increases or decreases pressure provided by the pressure increase zone, provided that the resulting pressure is still higher than the fluid pressure before entering the process described herein. For example, if the pressure increase zone increases by 1 bar the liquid pressure, the high intensity mixing zone could decrease the pressure by 0.1 bar, such that the liquid is still operating at a pressure higher than the one possessed by the same before entering the process. The mixing zone is formed in a treatment chamber. The liquid stream in the mixing zone is mixed with a mixer, for example a pump or any other mixing device. The treatment chamber can therefore comprise a volume within the mixer itself. In some embodiments, the mixer comprises a centrifugal mixer. In some embodiments, the mixer comprises an impeller, for example a powered rotating impeller. In some embodiments, the fluid moving device and the mixer are both pumps. The fluid moving device and the mixer may be the same type of device or different types of devices.

In the process, mixing intensity, for example centrifugal mixing intensity, in the mixing zone is controlled to help optimize mass transfer of the degradation reagent into the liquid stream and therefore the extent of degradation of the chemical compound. In addition, where two or more inter-reactive degradation reagents are utilized, controlling the mixing intensity helps establish high reaction efficiency between the two reagents.

The mixing intensity is controlled in a range of 0.7 W/L to 700 W/L. In some embodiments, the mixing intensity is in a range of 50 W/L to 500 W/L. In some embodiments, the mixing intensity is in a range of 60 W/L to 360 W/L. In some embodiments, the mixing intensity is in a range of 120 W/L to 300 W/L. Mixing intensity is mixing power input per volume. The mixing power is directly related to the speed at which the mixer is operated. Therefore, to obtain the desired mixing intensity, the speed of the mixer, for example a centrifugal mixer, is controlled in a range of 500 rpm to 9, 500 rpm. In some embodiments, the speed is controlled in a range of 1,000 rpm to 5,000 rpm. In sone embodiments, the speed is controlled in a range of from 1,200 rpm to 3,600 rpm (i.e., 20-60 Hz). In some embodiments, the speed is 1, 800 rpm (i.e., 30 Hz) or greater. In some embodiments, the speed is in a range of from 2,400 rpm to 3,300 rpm (i.e., 40-55 Hz). Depending on the scale of treatment system, volume of the treatment chamber may be in a range of 2 L to 20,000 L. The process can be configured to have an overall architecture comprising modular treatment processes connected in parallel and/or in series to serve the desired flow and achieve the desired performance.

In the process, the pressure between the pressure increase zone and the mixing zone, which includes the pressure in the treatment chamber, is controlled to help optimize mass transfer of the degradation reagent into the liquid stream. Thus, the pressure is maintained in a range of from 0.1 bar to 10 bar. In some embodiments, the pressure is maintained in a range of from 1 bar to 10 bar. In some embodiments, the pressure is maintained in a range of from 1 bar to 5 bar. In some embodiments, the pressure is maintained in a range of from 1.25 bar to 4 bar. In some embodiments, the pressure is maintained in a range of from 1.5 bar to 4 bar. In some embodiments, the pressure is maintained in a range of from 1.25 bar to 3 bar. In some embodiments, the pressure is maintained in a range of from 1.6 bar to 3 bar. The pressure may be maintained by operation of the fluid moving device and/or by utilizing a valve. The valve may be a simple valve or a back-pressure regulator. The valve can be manually or automatically operated in response to changing pressure. In some embodiments, the valve is downstream of the mixing zone.

In the process, the residence time of the liquid stream between the pressure increase zone and an outlet of the mixing zone may also be controlled to optimize dissolution of the degradation reagent in the liquid stream. The residence time may also be controlled to optimize production of secondary oxidizing and reducing species involved in the treatment. In addition, where two or more inter-reactive degradation reagents are utilized, controlling the residence time also helps establish high reaction efficiency between the two reagents. In some embodiments, the liquid stream has a residence time between the pressure increase zone and an outlet of the treatment chamber in a range of from 0.1 second to 100 seconds. In some embodiments, the residence time is in a range of 0.1 second to 60 seconds. In some embodiments, the residence time is in a range of 0.1 second to 40 seconds. In some embodiments, the residence time is in a range of 1 second to 36 seconds.

Degradation reagents are chemicals introduced into the liquid stream that cause degradation of unwanted chemical compounds in the liquid stream. The degradation may be either by direct or indirect reaction mechanisms. Such mechanisms can either be active in-situ (i.e., in the primary liquid stream) or ex-situ (e.g., in the secondary liquid stream). In the latter case, the secondary liquid stream is injected in the primary liquid stream as a degradation reagent to degrade the unwanted chemical compound present in the liquid stream. The unwanted chemical compound could also be a plurality of unwanted chemical compounds (or pollutants) or a physico-chemical property of the fluid (e.g., total organic carbon, hardness, salinity, transmittance, etc.). The type of degradation mechanism used can depend on the chemical compounds to be degraded or physico-chemical properties to be modified by the process. The degradation mechanisms are often oxidative or reductive in nature. The degradation reagent may be introduced into the liquid stream in any suitable physical form including gas, liquid and solid. Gases and liquids are typically the simplest to introduce into the liquid stream resulting in higher mass transfer of the degradation reagent into the liquid stream than solids. Liquid degradation reagents may be pure liquids or solutions. Some examples of degradation reagents include ozone (O₃), chlorine (Cl₂), chlorine dioxide (ClO₂), hydrogen peroxide (H₂O₂), hypochlorite (HClO⁻), potassium permanganate (KMnO₄), ferric chloride (FeCl₃), potassium dichromate (K₂Cr₂₀₇), nitric acid (HNO₃), potassium iodate (KIO₃), potassium persulfate (K₂S₂O₈), chloramines (pre-formed or in situ-formed), peracids (e.g., peracetic acid, performic acid), sodium sulfite (Na₂SO₃), sodium bisulfite (NaHSO₃), sodium borohydride (NaBH₄), ascorbic acid (Vitamin C), ferrous sulfate (FeSO₄), sodium dithionite (Na₂S₂O₄), hydroquinone (C₆H₆O₂), sodium formate (HCOONa), sodium hydrosulfite (Na₂S₂O₄), sodium amalgam (NaHg), ionic fluids, hydrogen, oxygen, nitrogen, argon, activated carbon, zeolites, resins, polymers (e.g., geopolymers), coagulants, sludge, biochar, synthetic absorbents, natural absorbents, clay and the like. In some embodiments, more than one degradation reagent may be utilized in the process.

Degradation reagents can be injected into the liquid stream at various injection zones in the liquid stream pathway. However, in the process at least one of the injection zones is between the pressure increase zone (i.e., the location of a fluid moving device) and a mixing zone. Mass injection rate of the degradation reagent is an important factor for increasing mass transfer efficiency of the degradation agent into the liquid stream for ultimately optimizing efficient degradation of the chemical compounds. In addition, where two or more inter-reactive degradation reagents are utilized, controlling the mass injection rate helps establish high reaction efficiency between the two reagents. As such, mass injection rate, especially at the injection zone between the pressure increase zone and the mixing zone, is preferably in a range of 30-200 g/hr or 45-160 g/hr, for example 54-120 g/hr, for a liquid stream flow rate in a range of 1-10 m³/hr. The mass injection rate scales with the liquid stream flow rate.

In some embodiments, the mass injection rate provides a concentration·time (CT) dose in a range of 0-2,000 mg/L·min. For strong oxidants (e.g., ozone, chlorine, performic acid, etc.), the CT may be in a range of from 0.1 mg/L·min to 10 mg/L·min, especially 0.1 mg/L·min to 5 mg/L·min, for example 0.1 mg/L·min to 1 mg/L·min. For weak oxidants (e.g., chloramines, peracetic acid, etc.) the CT may be in a range of from 0.1 mg/L·min to 100 mg/L·min. For radicals, the CT may be in a range of less than 0.1 mg/L·min. For absorbents or ion resins the CT may be in a range of 0.1 mg/L·min to 2,000 mg/L·min. For other oxygen and non-oxygen reactive species, the CT may be in a range of 0.1 mg/L·min to 1 mg/L·min. Introduction of the degradation reagent into the liquid stream may be accomplished by injecting the degradation reagent with an injector, preferably a high-pressure injector (e.g., a high-pressure needle injector) that can inject the degradation agent into the liquid stream at a pressure meeting or exceeding the pressure in the treatment chamber. Some suitable injectors include, for example L-shaped injectors, microchannel injectors, needle injectors, nanobubble injectors, microreactor injectors, U-shaped injectors, venturi injectors, fixed throat type injectors, and adjustable throat injectors. In some process configurations, the injector can be used as a side-stream apparatus to produce secondary oxidizing or reducing species to be introduced in the primary liquid stream. In addition to an injection zone between the pressure increase zone and the mixing zone, the process may include one or a plurality of other injection zones. One or more of the other injections zones may also be between the pressure increase zone and the mixing zone, upstream of the pressure increase zone or downstream of the mixing zone.

Higher partial pressure of gaseous reagents or higher concentration of the degradation reagent in an injectable material is suitable to efficiently degrade the chemical compound. The concentration depends on the nature of degradation reagent and on the physical conditions under which the injection occurs. Higher pressure is desirable as it increases the partial pressure of the gaseous reagent and the solubility of other reagents. Generally, a concentration of 5 wt % or more is desirable with higher concentrations leading to faster and more efficient degradation. Short retention time between the exit point of the degradation reagent and the liquid injection point is desirable as it minimizes reagent losses by parasitic self-decomposition reactions. In some embodiments, the concentration of the degradation reagent in the injectable material is 10 wt % or more. In some embodiments, the concentration of the degradation reagent in the injectable material is in a range of 5-50 wt %. In some embodiments the concentration of the degradation reagent in the injectable material is in a range of 10-50 wt %. In some embodiments, the concentration of the degradation reagent in the injectable material is in a range of 10-20 wt %.

When more than one degradation reagent is utilized in the process, one or more of the degradation reagents is introduced into the liquid stream between the pressure increase zone and the mixing zone. Other degradation reagents may be introduced into the liquid stream upstream of the pressure increase zone, for example before introducing the liquid stream to the inlet of a pump used in the pressure increase zone. Other degradation reagents may be introduced into the liquid stream downstream of the mixing zone. Two or more of the degradation reagents may be inter-reactive undergoing a reaction to produce another reactive species that can serve to degrade certain chemical compounds. In some embodiments, hydrogen peroxide is utilized in combination with another degradation reagent (e.g., ozone) such that the reaction between the hydrogen peroxide and the other degradation reagent produces hydroxyl ions, which are effective at degrading certain chemical compounds. In some embodiments of hydrogen peroxide and another degradation reagent (e.g., ozone), the degradation reagent is introduced into the liquid stream in an amount to achieve a molar ratio of the degradation reagent to the hydrogen peroxide in a range of from 0.1:1 to 10:1, for example 1.7:1 to 2:1.

In some embodiments, the process includes one or more other modes for treating the liquid stream, for example exposure to vacuum ultraviolet (VUV) light, exposure to ultraviolet (UV) light, exposure to visible (Vis) light, exposure to infrared (IR) light, sonication, ultrasonication, maceration, blending, grinding, pressure compression, pressure decompression, expansion, particle size reduction, filtration, biofiltration, membrane filtration, photocatalysis, ultrasound, electrocoagulation, electrolysis, advanced reduction processes, sedimentation, digestion, fermentation, and the like. One or more of the other treatment modes may be utilized upstream of the pressure increase zone, downstream of the mixing zone, between the pressure increase zone and the mixing zone or some combination thereof.

The chemical compound to be degraded is considered a pollutant in the liquid stream. The liquid stream can contain a plurality of chemical compounds. Some categories of chemical compounds include, for example, biological compounds (e.g., microbial communities, microbes, proteins (e.g., enzymes), polynucleotides (e.g., DNA, RNA), lipids), pharmaceuticals (e.g., antibiotics), personal care products, olefins, endocrine disruptors (e.g., hormones), pesticides, petroleum hydrocarbons, halogenated organic compounds (e.g., fluorinated compounds (such as polyfluoroalkyl substances (PFAS) compounds) and chlorinated compounds (such as polychlorinated biphenyls (PCBs)), nitroaromatic compounds, flame retardants, organic compounds in industrial wastewater (e.g., phenolic compounds, polycyclic aromatic hydrocarbons (PAHs), dioxin and furan compounds) and heavy metals. Some specific examples of chemical compounds to be degraded in trihalomethanes, 4-chlorobenzoic the liquid stream are: acid, perfluorohexanoic acid, perfluorooctanoic acid, caffeine, acetaminophen, ciprofloxacin, carbamazepine and sulfamethoxazole. The process could also be configured to control the production of disinfection byproducts, for example by adding hydrogen peroxide prior to gaseous ozone thus preventing the formation of bromate. Similarly, the formation of dichloramine could be prevented by controlling the pH with an acid or a base, and by using stoichiometric ratio of treatment reagents. It is also possible to configure the process to allow in-situ formation of hydroxyl radicals via advanced oxidation processes, hydrated electrons via advanced reduction processes or disinfectants and metal hydroxides via combined oxidation-reduction processes (e.g., the simultaneous addition of sodium hypochlorite and aluminum chloride to form chlorine gas and aluminum hydroxide).

In the present invention, a degradation reagent is injected into a liquid stream in the presence of high intensity mixing in a confined pressurized volume. Under such circumstances, unexpected physico-chemical behaviors occur. These physico-chemical behaviors are used to optimize the injection and the reaction of the degradation reagent in a fluid treatment process and system. Unlike other methods and systems, the process described herein operates by promoting conditions, especially pressure conditions, that are inhomogeneous throughout the liquid stream, thereby driving reagents away from reaching an equilibrium state. Under these inhomogeneous (turbulent) conditions, diffusion, solubility, fluid dynamics, turbulence and surface tension never reach equilibrium. Since achieving equilibrium conditions is known to induce limits to mass transfer and reactivity in a physico-chemical system, avoiding equilibrium conditions accelerates diffusion (mass transfer) and rate of reaction (reactivity) of the degradation reagent in the liquid stream, thereby permitting shorter residence times of the liquid stream in the mixing zone, resulting in lower CT dose and promoting greater degradation efficiency in a smaller footprint of the system.

By coupling high-pressure conditions with appropriate high intensity mixing dynamics to produce inhomogeneous pressure gradients throughout the liquid stream in the mixing zone, the dispersion and reorganization of the degradation material into nanopockets, as described by the principles of surface tension, also play a significant role. Particularly when the degradation reagent is a gas, surface tension tends to minimize the surface area of nanobubbles of the gas, causing the nanobubbles to contract and implode. Additionally, pressure differentials and gas expansion can cause the nanobubbles to expand and potentially explode. These physical phenomena, influenced by the principles of surface tension, contribute to the nanobubble formation, and affect the reactivity of the gas, such as ozone, within the liquid stream. By controlling pressure and mixing, turbulence is controlled so that the system achieves efficient diffusion and solubility of degradation reagents in the liquid stream. The reorganization of the degradation reagents into nanopockets (e.g., nanobubbles for gases) enhances the reactivity, and these physical processes collectively improve the performance and effectiveness of the process.

Further, under the inhomogeneous conditions provided in the present process, combinations of various degradation reagents interact synergistically to further improve degradation efficiency. For example, ozone and sodium hypochlorite can produce in-situ reactive oxygen species and radical species. The ozonation-chlorination process can lead to the generation of highly reactive intermediates, such as hydroxyl radicals (OH.) and chlorine radicals (Cl.). These radicals are strong oxidizing agents and can participate in further reactions. The combination of ozone and sodium hypochlorite can synergistically enhance the oxidation and disinfection capabilities compared to using either ozone or sodium hypochlorite alone. The reactive species produced can effectively degrade organic pollutants, eliminate microorganisms, and remove odors. Similarly, sulfur radicals could be formed if persulfate reagents are used instead of oxidants. Sulfur radicals are particularly useful in producing hydrated electrons, hence promoting advanced reduction processes.

The present invention further provides for a system for degrading a chemical compound in a liquid stream as described below.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a schematic diagram of an embodiment of a system for conducting a process for degradation of a chemical compound in a liquid stream.

FIG. 2 depicts a schematic diagram of another embodiment of a system for conducting a process for degradation of a chemical compound in a liquid stream.

FIG. 3 depicts a schematic diagram of another embodiment of a system for conducting a process for degradation of a chemical compound in a liquid stream.

FIG. 4 depicts a schematic diagram of another embodiment of a system for conducting a process for degradation of a chemical compound in a liquid stream.

FIG. 5 depicts a schematic diagram of another embodiment of a system for conducting a process for degradation of a chemical compound in a liquid stream.

FIG. 6 depicts a schematic diagram of another embodiment of a system for conducting a process for degradation of a chemical compound in a liquid stream.

FIG. 7 depicts a schematic diagram of another embodiment of a system for conducting a process for degradation of a chemical compound in a liquid stream.

FIG. 8 depicts a schematic diagram of another embodiment of a system for conducting a process for degradation of a chemical compound in a liquid stream.

FIG. 9 depicts a schematic diagram of another embodiment of a system for conducting a process for degradation of a chemical compound in a liquid stream.

FIG. 10 depicts a schematic diagram of another embodiment of a system for conducting a process for degradation of a chemical compound in a liquid stream.

FIG. 11 depicts a schematic diagram of another embodiment of a system for conducting a process for degradation of a chemical compound in a liquid stream.

FIG. 12 depicts a schematic diagram of another embodiment of a system for conducting a process for degradation of a chemical compound in a liquid stream.

FIG. 13 depicts a schematic diagram of another embodiment of a system for conducting a process for degradation of a chemical compound in a liquid stream.

FIG. 14A depicts a top view of an example of a system for conducting a process for degradation of a chemical compound in a liquid stream.

FIG. 14B depicts a side view of FIG. 14A.

FIG. 14C depicts a side view of FIG. 14A perpendicular to FIG. 14B.

FIG. 15A depicts a 3D surface plot of measured dissolved ozone (mg/L), pressure (bar) and impeller speed (Hz) in a treatment chamber of the system of FIG. 14A to determine optimal pressure and impeller speed for mass transfer of ozone into a water stream during operation of the system.

FIG. 15B depicts a 3D surface plot of measured dissolved ozone (mg/L), pressure (bar) and residence time(s) of the ozone in a treatment chamber of the system of FIG. 14A to show interdependency and optima in ozone mass transfer in the treatment chamber.

FIG. 16A depicts a 3D surface plot of impeller speed (Hz) and residence time(s) of ozone vs. molar ratio of reacted ozone to hydrogen peroxide in a treatment chamber of the system of FIG. 14A to show interdependency and optima of the molar ratio of reacted ozone over reacted hydrogen peroxide.

FIG. 16B depicts a 3D surface plot of impeller speed (Hz) and injected ozone mass rate (g/hr) vs. molar ratio of reacted ozone to hydrogen peroxide in a treatment chamber of the system of FIG. 14A to show interdependency and optima of the molar ratio of reacted ozone over reacted hydrogen peroxide.

FIG. 17 depicts a 3D surface plot of injected ozone mass rate (g/hr) vs. impeller speed (Hz) in a process for the degradation of 4-chlorobenzoic acid (pCBA) in which all other factors were kept constant and equal to their average values.

FIG. 18A depicts a graph of caffeine concentration (c) in a water stream after treatment with ozone in a process for the degradation of caffeine relative to original concentration (c.) of caffeine vs. impeller speed (Hz) in which all other factors were kept constant and equal to their average values.

FIG. 18B depicts a graph of caffeine concentration (c) in a water stream after treatment with ozone in a process for the degradation of caffeine relative to original concentration (co) of caffeine vs. ozone mass rate (g/hr) in which all other factors were kept constant and equal to their average values.

FIG. 19 depicts a graph of perfluorooctanoic acid (PFOA) concentration (pg/L) vs. concentration·time (CT) dose (mg/L) of ozone in a wastewater stream after treatment with ozone in a process for the degradation of PFOA in which all other factors were kept constant and equal to their average values.

FIG. 20 depicts a 3D surface plot of absorbance at 254 nm (1/m) vs. concentration·time (CT) dose (mg/L) of ozone (O₃) and concentration·time (CT) dose (mg/L) of hydrogen peroxide in a wastewater stream after treatment with ozone and sodium hypochlorite in which all other factors were kept constant and equal to their average values.

FIG. 21 depicts a 3D surface plot of chemical oxygen demand (COD) (μg/L) vs. concentration·time (CT) dose (mg/L) of ozone (O₃) and concentration·time (CT) dose (mg/L) of hydrogen peroxide in a wastewater stream after treatment with ozone and sodium hypochlorite in which all other factors were kept constant and equal to their average values.

FIG. 22 depicts a 3D surface plot of sum of micropollutants (mg/L) vs. concentration·time (CT) dose (mg/L) of ozone (O₃) and concentration·time (CT) dose (mg/L) of hydrogen peroxide in a wastewater stream after treatment with ozone and sodium hypochlorite in which all other factors were kept constant and equal to their average values.

### DETAILED DESCRIPTION

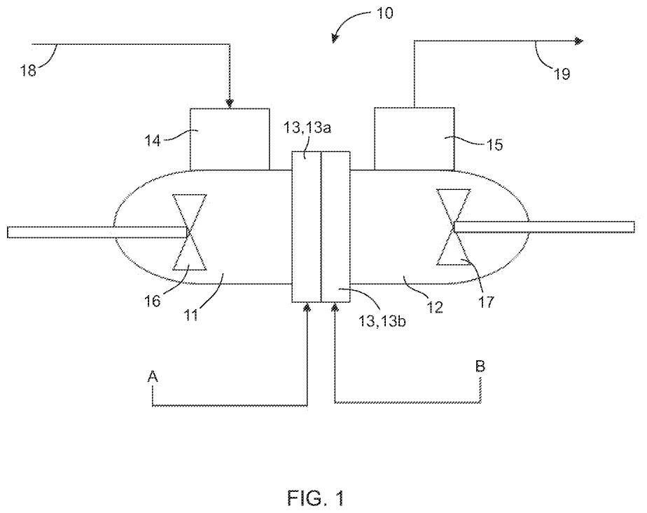

FIG. 1 to FIG. 13 are schematic diagrams of thirteen embodiments of a system for conducting a process for degradation of a chemical compound in a liquid stream.

FIG. 1 depicts a system 10 for conducting a process for degradation of a chemical compound in a liquid stream. A liquid stream 18 containing the chemical compound flows into the system 10 through an inlet 14. The inlet 14 is in fluid communication with a pressure increase zone 11 where a fluid moving device 16 (e.g., a pump or other device with an impeller) propels the liquid stream 18 under pressure into a treatment chamber that comprises a mixing zone 12. The system 10 also comprises a plurality of degradation reagent injection zones 13 having injector for injecting degradation reagents into the liquid stream. In the system 10, the liquid stream 18 from the pressure increase zone 11 enters a first degradation reagent injection zone 13a where a first degradation reagent A is injected into the liquid stream 18 and then a second degradation reagent injection zone 13b where a second degradation reagent B is injected into the liquid stream 18. The liquid stream 18, containing the degradation reagents A and B, enters the mixing zone 12 where the degradation reagents A and B are intimately mixed with the liquid stream 18 by a centrifugal mixer 17 (e.g., an impeller). Treated from the treatment chamber flows out of the mixing zone 12 through an outlet 15 as a treated liquid stream 19. Pressure in the treatment chamber can be controlled through operation of the fluid moving device 16.

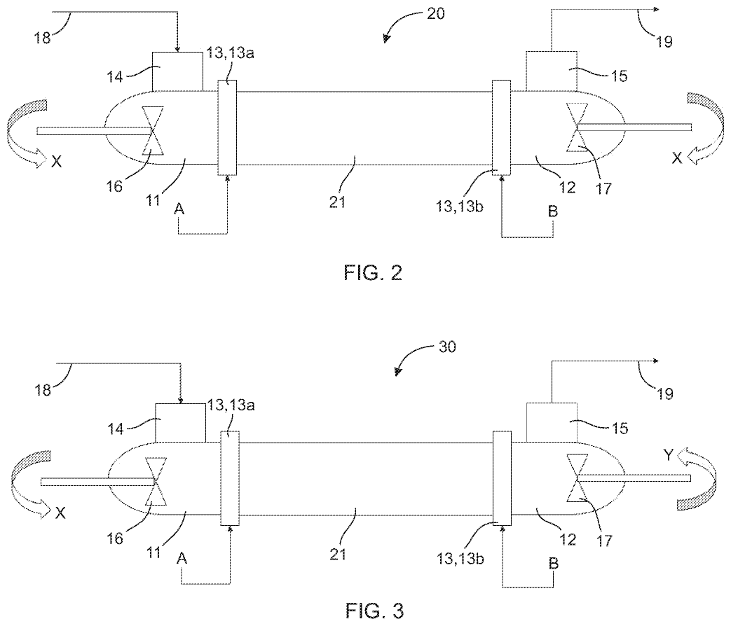

FIG. 2 depicts another embodiment in which a system 20 comprises elements 11, 12, 13, 14, 15, 16, 17, 18 and 19 of the system 10 except that a path length of the treatment chamber is extended by insertion of an extension chamber 21 (e.g., a length of pipe or tube) between the first degradation reagent injection zone 13a and the second degradation reagent injection zone 13b. Further, the fluid moving device 16 comprises a pump that has an impeller that is co-rotated with the centrifugal mixer 17 in a rotational direction X. Such an arrangement provides for greater residence time of the liquid stream 18 in the treatment chamber.

FIG. 3 depicts another embodiment in which a system 30 comprises elements 11, 12, 13, 14, 15, 16, 17, 18, 19 and 21 of the system 20 except the fluid moving device 16 has an impeller that is counter-rotated with the centrifugal mixer 17, for example the impeller rotates in the rotational direction X but the centrifugal mixer 17 rotates in a rotational direction Y. Such an arrangement provides for different mixing mechanics for the liquid stream 18 in the treatment chamber.

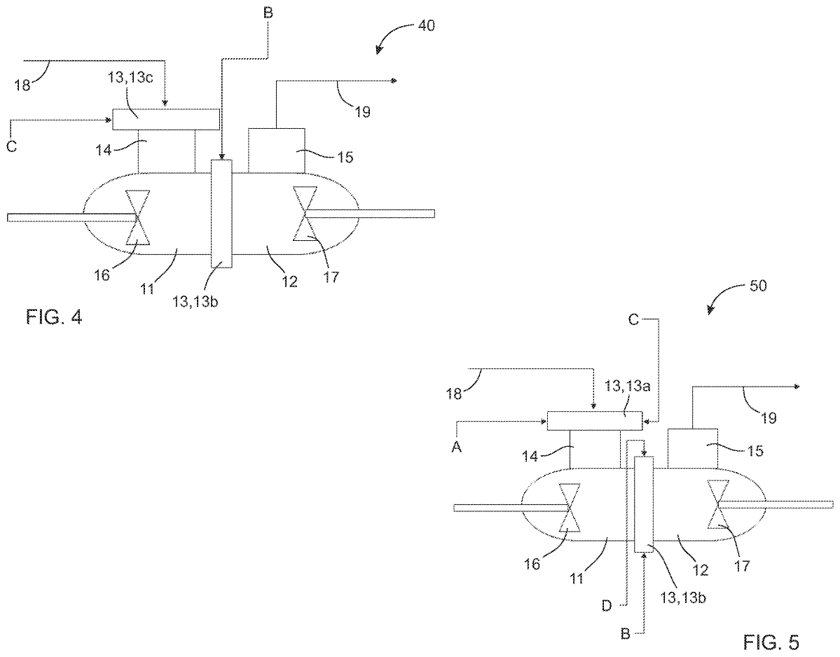

FIG. 4 depicts another embodiment in which a system 40 comprises elements 11, 12, 13, 14, 15, 16, 17, 18 and 19 of the system 10 except that the first degradation reagent injection zone 13a is situated upstream of the inlet 14. Such an arrangement provides for greater residence time of the first degradation reagent A in the liquid stream 18 without increasing the residence time of the liquid stream 18 in the treatment chamber.

FIG. 5 depicts another embodiment in which a system 50 comprises elements 11, 12, 13, 14, 15, 16, 17, 18 and 19 of the system 40 except that the first degradation reagent injection zone 13a comprises two ports for simultaneous injection of both the first degradation reagent A and a third degradation reagent C. Likewise, the second degradation reagent injection zone 13b comprises two ports for simultaneous injection of both the second degradation reagent B a fourth degradation reagent D. Such an arrangement permits injection of more than two degradation reagents into the liquid stream 18.

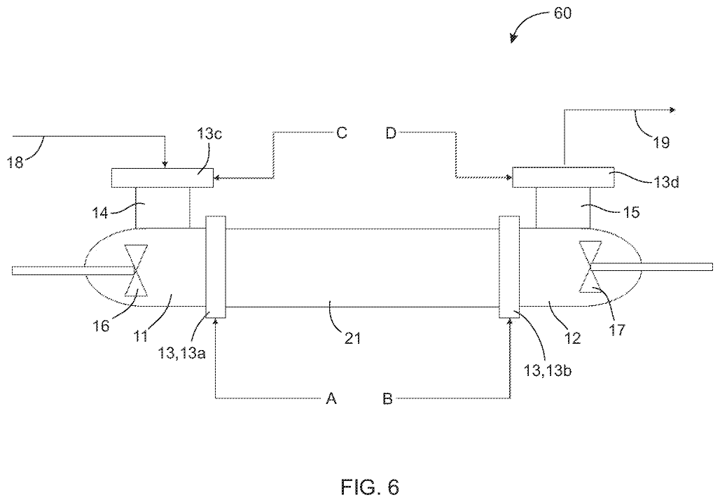

FIG. 6 depicts another embodiment in which a system 60 comprises elements 11, 12, 13, 14, 15, 16, 17, 18, 19 and 21 of the system 20 except that the plurality of degradation reagent injection zones 13 comprises a third degradation reagent injection zone 13c situated upstream of the inlet 14 and a fourth degradation reagent injection zone 13d situated downstream of the outlet 15. A third degradation reagent C is injected into the liquid stream 18 in the third degradation reagent injection zone 13c. A fourth degradation reagent D is injected into the treated liquid stream 19 in the fourth degradation reagent injection zone 13d. Such an arrangement permits injection of a degradation reagent into the treated liquid stream 19 for further treatment of the liquid stream.

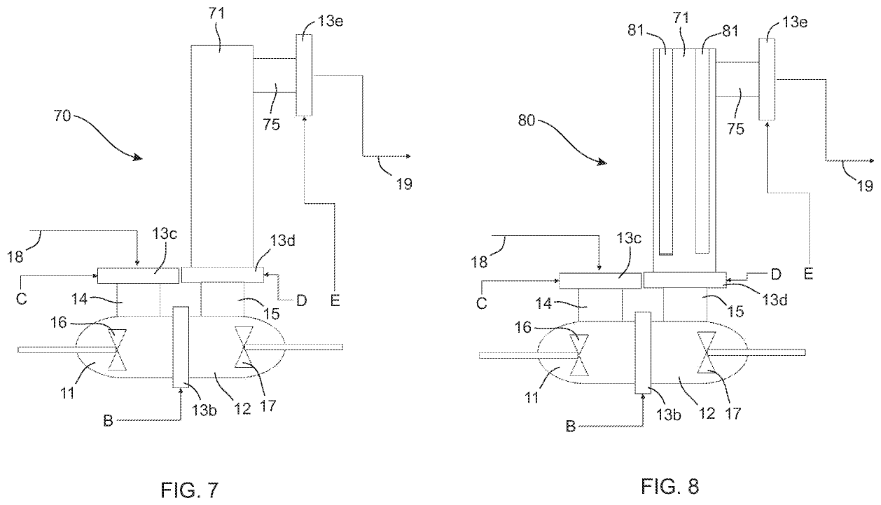

FIG. 7 depicts another embodiment in which a system 70 comprises elements 11, 12, 13, 14, 15, 16, 17, 18 and 19 of the system 40 except that a post-treatment chamber 71 is inserted downstream of the outlet 15 with a fourth degradation reagent injection zone 13d inserted between the outlet 15 and the post-treatment chamber 71 for injecting a fourth degradation reagent D into the treated liquid leaving the outlet 15. In addition, the post-treatment chamber 71 has its own post-treatment outlet 75 downstream thereof and the system 70 comprises a fifth degradation reagent injection zone 13e downstream of post-treatment outlet 75 for injecting a fifth degradation reagent E into the as the treated liquid stream 19 exits the system 70. Such an arrangement permits further treatment of the liquid stream downstream of the mixing zone 12.

FIG. 8 depicts another embodiment in which a system 80 comprises elements 11, 12, 13, 14, 15, 16, 17, 18, 19, 71, 75 of the system 70 except that the post-treatment chamber 71 is equipped with ultraviolet (UV) lamps 81 for further treating the liquid in the post-treatment chamber 71. Such an arrangement permits UV treatment of the liquid stream downstream of the mixing zone 12.

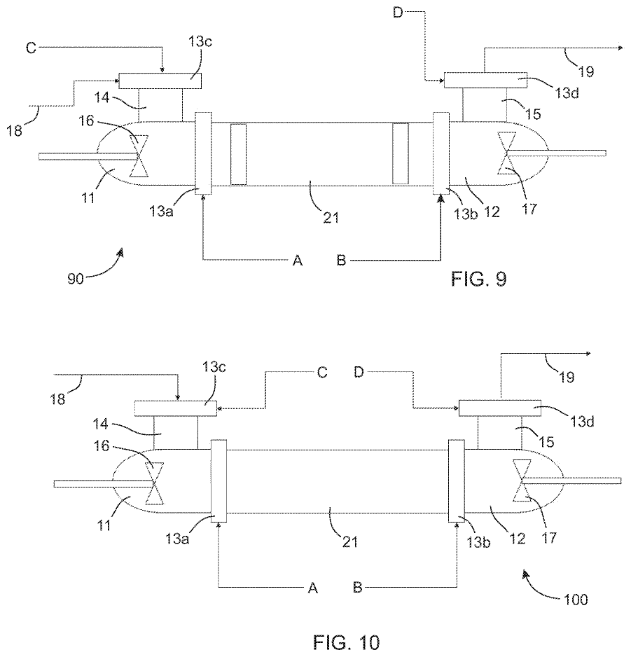

FIG. 9 depicts another embodiment in which a system 90 comprises elements 11, 12, 13, 14, 15, 16, 17, 18, 19 and 21 of the system 60 except that the extension chamber 21 is equipped with ultraviolet (UV) lamps 91 for treating the liquid stream 18 in the extension chamber 21. Such an arrangement permits UV treatment of the liquid stream 18 in the treatment chamber.

FIG. 10 depicts another embodiment in which a system 100 comprises elements 11, 12, 13, 14, 15, 16, 17, 18, 19 and 21 of the system 90 except that the extension chamber 21 is equipped with a filtration unit for treating the liquid stream 18 in the extension chamber 21. Such an arrangement permits filtration of the liquid stream 18 in the treatment chamber.

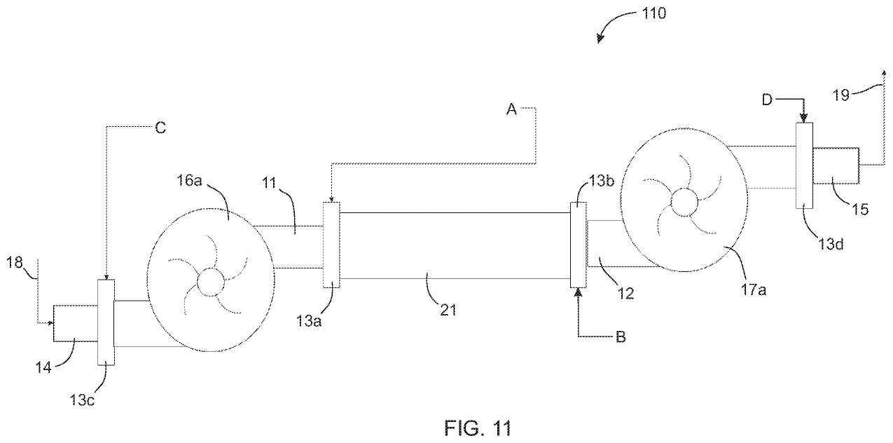

FIG. 11 depicts another embodiment in which a system 110 comprises elements 11, 12, 13, 14, 15, 16, 17, 18, 19 and 21 of the system 60 except that the fluid moving device 16 is specifically a first pump 16a, the centrifugal mixer 17 is specifically a second pump 17a and the configuration of the various elements with respect to each other is somewhat different though the liquid stream 18 flows through the elements in the same order as in the system 60.

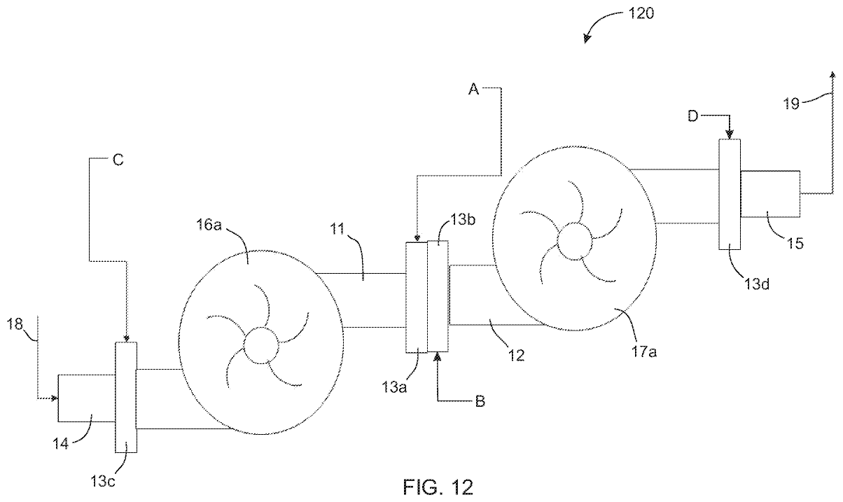

FIG. 12 depicts another embodiment in which a system 120 comprises elements 11, 12, 13, 14, 15, 16a, 17a, 18 and 19 of the system 110 except that the extension chamber 21 has been removed so that the first degradation reagent injection zone 13a and the second degradation reagent injection zone 13b are immediately adjacent each other like the system 10 in FIG. 1.

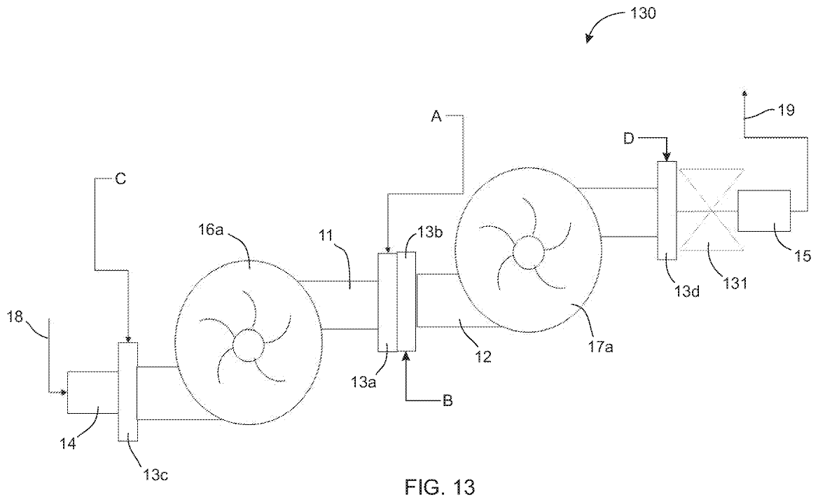

FIG. 13 depicts another embodiment in which a system 130 comprises elements 11, 12, 13, 14, 15, 16a, 17a, 18 and 19 of the system 120 except that a pressure regulator 131 (e.g., a valve) is inserted between the mixing zone 12 and the outlet 15. The pressure regulator 131 can be operated to help maintain a desired pressure in the treatment chamber.

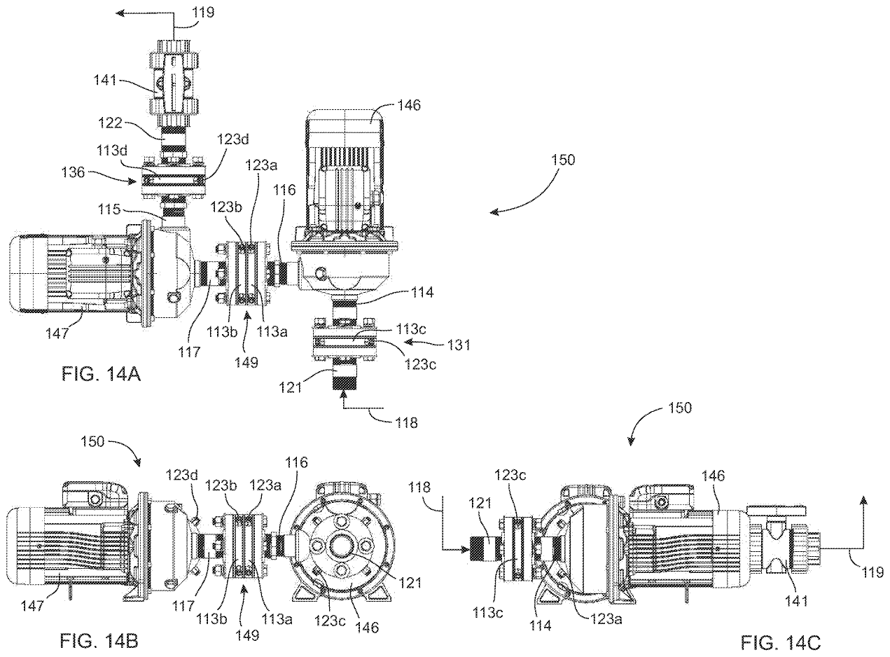

FIG. 14A, FIG. 14B and FIG. 14C depict an example of a system 150 for conducting a process for degradation of a chemical compound in a liquid stream in which a first high speed centrifugal pump 146 is fluidically connected in series to a second high speed centrifugal pump 147. The first pump 146 receives a liquid stream 118 to be treated through a first pump inlet 114 and pumps the liquid stream 118 through a first pump outlet 116 into a main injection zone 149 between the first pump 146 and the second pump 147. The liquid stream 118 pumped through the main injection zone 149 enters the second pump 147 through a second pump inlet 117 to be mixed in the second pump 147 with any degradation reagents introduced into the liquid stream 118 in the main injection zone 149. The treatment chamber comprises the second pump 147 (i.e., a cavity in the second pump 147 and the second pump inlet 117). A treated liquid stream 119 is pumped out of the second pump 147 through a second pump outlet 115. The main injection zone 149 comprises flanges 113a, 113b that are bolted together and mounted on the first pump outlet 116 and second pump inlet 117. The flanges 113a, 113b have central holes to permit the liquid stream 118 to flow therethrough. The flange 113a comprises a plurality of injection ports 123a situated annularly around the flange 113a that are configured to permit injection of degradation reagents into the central bore and therefore into the liquid stream 118 flowing therethrough. Likewise, the flange 113b comprises a plurality of injection ports 123b situated annularly around the flange 113b that are configured to permit injection of degradation reagents into the central bore and therefore into the liquid stream 118 flowing therethrough. The injection ports 123a and 123b are preferably configured to permit injecting gases (e.g., ozone, chlorine and the like) into the liquid stream 118.

The system 150 further comprises a pre-injection zone 131 and a post-injection zone 136. The pre-injection zone 131 permits injection of degradation reagents into the liquid stream 118 before the liquid stream 118 enters the first pump 146. The pre-injection zone 131 comprises a pre-flange 113c mounted on the first pump inlet 114 and on a system inlet 121. The pre-flange 113c has a central bore to permit the liquid stream 118 to flow therethrough. The pre-flange 113c comprises a plurality of injection ports 123c situated annularly around the pre-flange 113a that are configured to permit injection of degradation reagents into the central bore and therefore into the liquid stream 118 flowing therethrough. The post-injection zone 136 permits injection of more degradation reagents into the treated liquid stream 119 after the treated liquid stream 119 exits the second pump 147. The post-injection zone 136 comprises a post-flange 113d mounted on the second pump outlet 115 and on a system outlet 122. The post-flange 113d has a central bore to permit the treated liquid stream 119 to flow therethrough. The post-flange 113d comprises a plurality of injection ports 123d situated annularly around the post-flange 113d that are configured to permit injection of more degradation reagents into the central bore and therefore into the treated liquid stream 119 flowing therethrough. The injection ports 123c and 123d are preferably configured to permit injecting liquids (e.g., hydrogen peroxide, hypochlorite solutions and the like) into the respective liquid streams.

The system 150 further comprises a pressure regulator 141 (e.g., a simple valve, an automatic back pressure regulator, or the like) situated in the treated liquid stream 119 downstream of the second pump 147 and, in this embodiment, downstream of the post-injection zone 136. The pressure regulator 141 is operable to control the pressure in the treatment chamber, the treatment chamber.

### EXAMPLES

### Materials and Methods

### Preparation of Spiking Solutions

A 1000-gallon inlet tank was spiked with a particular contaminant solution which was a combination of some of the following components depending on the objective: methylene blue, 4-chlorobenzoic acid, pharmaceuticals, methanol for organic carbon, and sodium nitrite. The inlet tank was filled with dechlorinated water and used as is for Example 1 and Example 2. For Example 3, the water was further spiked with contaminants to have a final concentration of about 5 mg/L methylene blue, 500 μg/L of 4-chlorobenzoic acid (pCBA), 150 μg/L of acetaminophen, 150 μg/L of caffeine, 50 μg/L of ciprofloxacin, 50 μg/L of carbamazepine, and 50 μg/L of sulfamethoxazole. One set of runs of Example 3 were conducted by altering the water quality by adding, beside the above-mentioned contaminants, also 5 mg/L of NaNO₂ (as ozone scavenger) and 10 mg/L of total organic carbon (TOC) using methanol (as radical scavengers). The operating procedure for technology testing can be summarized as follows:
1. Fill the inlet of the 1000-gallon tank with dechlorinated water.
2. Add contaminants to the desired concentrations.
3. Mixed the tank to ensure uniform feed characteristics.
4. Run the pilot system with the batch of water prepared.
5. Take samples before and after the pilot system.

### Ozone Residual Test Method

Ozone residual testing was out using carried Chemetrics™ Ozone Vacu-vials Kit K-7423 with a Hach DR3900 Spectrophotometer set to 515 nm. All reagents were purchased through Chemetrics™. Five drops of the A-7400 activator solution were added to a sample cup and 25 mL of sample was then added to the cup. A vacuum ampule was cracked inside the solution. The contents were mixed, and the absorbance was read on the spectrophotometer. Absorbance was used to calculate the concentration of ozone.

### Nitrate and Nitrite Test Method

Nitrate and nitrite standards were purchased from Hach™ in a concentration of 822 ppm NO₂⁻ and 44 ppm NO₃⁻. To make a calibration curve, six standards for NO₂⁻ and NO₃″ were made in RO water between 0.1 ppm and 20 ppm. The standards were run on a Metrohm™ 930 Compact IC Flex Ion Chromatography System. The column that was used was the Metrosep™ A Supp 5-150/4.0. The eluent was made by combining 0.32M/0.1M sodium carbonate/bicarbonate with 1 L of RO water and the eluent flow rate was 0.7 mL/min. The injection volume was 20 μL. The NO₂ peak was identified at a retention time of 7.4 min and the NO₃ peak was identified at a retention time of 10.5 min.

### Total Organic Carbon Test Method

Total Organic Carbon (TOC) testing was done using a TOC LR Hach™ kit and following the Hach™ 10129 Low Range TOC Method. The Hach DRB 200 was used to heat the samples according to the method and the Hach™ DR 900 to measure the TOC after the reaction has occurred.

### 4-Chlorobenzoic Acid Concentration Test Method

4-Chlorobenzoic acid (pCBA) test was carried out using an Agilent™ 1260 HPLC with a diode-array detector (DAD). Immediately after the samples were taken from the test system, 1 mL of 200 ppm sodium thiosulfate was added to 9 mL of the sample. The purpose of the sodium thiosulfate was to quench the sample by reacting with the residual hydrogen peroxide and ozone to ensure that the pCBA concentration remained unchanged while waiting for the HPLC analysis. The vial was mixed well and about 1 mL was filtered using nylon filters into a labelled HPLC vial. To make a calibration curve, seven pCBA standards between 0.005 ppm and 0.5 ppm were made in reverse osomosis (RO) water. The standards were run on the Agilent™ 1260 HPLC with a DAD detector. The column used was the Agilent Zorbax™ SB-C18 4.6×250 mm; 5 μm at a temperature of 25° C. The mobile phase was an isocratic mixture of 52% of 0.1% phosphoric acid in water and 48% acetonitrile at a flow rate of 1.5 mL/min. The injection volume was 100 μL and the detector was set to 238 nm. The pCBA peak was identified at a retention time of 3.9 min and the total run time was 6.5 min.

### Pharmaceuticals Concentration Test Method

Pharmaceutical testing was done using an Agilent™ 1260 HPLC with a triple quadrupole mass spectrometer detector (TQ). Immediately after the samples were taken from the test system, 1 mL of 200 ppm sodium thiosulfate was added to 9 mL of the sample. The purpose of the sodium thiosulfate was to quench the sample by reacting with the residual hydrogen peroxide and ozone to ensure that the pharmaceutical concentration remained unchanged while waiting for the HPLC analysis. The vial was mixed well and about 1 mL was filtered using nylon filters into a labelled HPLC vial. To make a calibration curve, seven pharmaceutical standards between 0.005 ppm and 0.5 ppm (containing caffeine, acetaminophen, ciprofloxacin, carbamazepine, sulfamethoxazole, and erythromycin) were prepared in RO water. The standards were run on the Agilent™ 1260 HPLC with a TQ detector. The column used was the Agilent Zorbax™ Eclipse C18 2.1×50 mm; 1.8 μm at a temperature of 35° C. The mobile phase was a gradient where A was 0.1% formic acid in water and B was acetonitrile at a flow rate of 0.4 mL/min. The injection volume was 100 μL and the total run time was 14 minutes. The following procedure was use:
1. Immediately after the sample is taken pipette 9 mL of sample into a 15 mL centrifuge tube.
2. Pipette 1 mL of 200 ppm sodium thiosulfate into the centrifuge tube to quench the sample and invert several times to mix well.
3. Use a nylon filter to filter about 1 mL of sample into a labelled HPLC vial.
4. Put sample into autosampler and run HPLC method.
5. If need to store sample to run later, store sample in freezer.
6. Use the calibration curve to determine the pharmaceuticals concentration from the peak areas.
7. Make sure to account for the dilution from the sodium thiosulfate addition.

### Methylene Blue Concentration Test Method

Methylene blue concentration testing was done using a Thermo Varioskan Lux™ Microplate Reader. The following standards were made for the calibration curve: 0.01 ppm, 0.1 ppm, 0.5 ppm, 1 ppm, 2 ppm, 3 ppm, 4 ppm. The Thermo Varioskan Lux™ was set up to read the absorbance of the given well at 664 nm. The absorbance of the standards was measured and plotted against the concentrations to create the calibration curve.

### Example 1: Mass Transfer Efficiency of Ozone into a Water Stream

This example is directed to determining under which conditions the proposed process provides the highest mass transfer efficiency of ozone. The system used is the one shown in FIG. 14A to FIG. 14C having a treatment chamber with a volume of about 3 L. The following process factors were varied one at a time or simultaneously: (a) impeller speed; (b) pressure of the fluid in the treatment chamber; (c) residence time of the fluid in the treatment chamber; and (d) mass rate of injected reagent (in this case, ozone gas). The injection pressure of the reagent (e.g., ozone gas, comprising a mixture of oxygen and ozone gases) was always kept constant at 3 bar for all the runs. This way, a reagent pressure greater than or equal to pressure of the treatment chamber was achieved in all tests. A general mass balance for ozone could be written as:

$$Residual Ozone = Ozone Transferred - Ozone Decomposed - Ozone Reacted with the Matrix . \qquad ( Eq . 1 )$$

All runs were carried out under specific water quality conditions established to simplify Eq. 1, which would allow the use dissolved oxygen as a proxy for mass-transfer efficiency. Specifically, all runs were conducted using clean tap water, further filtered with a granular activated carbon (GAC) filter to remove all the residual combined chlorine present in the stream as well as reduce the organic carbon of the fluid. Under those circumstances, it is possible to assume that:

$$Ozone Reacted with the Matrix << Ozone Transferred to the Liquid - Ozone Decomposed . \qquad ( Eq . 2 )$$

Given the constant water quality used in the runs, it is also possible to realistically expect that the ozone decomposition term reported in Eq. 1 (marked as “Ozone Decomposed”) will be mostly attributable to self-decomposition mechanisms. As such, the contribution of such term will be equal in all runs and can be approximated with a “constant”, which, despite being unknown, will be equal for all the runs. Under those conditions, Eq. 1 simplifies to Eq. 3:

$$Residual Ozone ( Liquid ) = Ozone Transferred ( Liquid ) - Constant . \qquad ( Eq . 3 )$$

The simplified form of this equation permits measuring the residual ozone (dissolved) in the fluid (water) and use the same as a proxy for mass-transfer efficiency. The higher the residual ozone measured, the higher the mass transfer efficiency.

The following factors were changed in each run to optimize mass-transfer efficiency: (a) pressure established in the treatment chamber by the first pump located immediately upstream the treatment chamber; (b) mass injection rate of reagent, in this case ozone gas, established by controlling the ozone gas concentration injected between the pump and the treatment chamber; (c) residence time in the treatment chamber; (d) mixing conditions in the treatment chamber established by setting the impeller speed at a desired rotation frequency.

These factors were changed each run either using controllable variables or indirectly by varying flowrate (for residence time) and pressure (using a valve located downstream the system). A factorial design was developed and executed by varying: (a) impeller speed=[0-60 Hz], (b) ozone mass injection rate: [54-120 g/hr], (c) fluid residence time=[8-40 seconds]. The multiple runs permitted implicitly altering the pressure in the treatment chamber, which varies between 0.5 and 3 bars (as absolute pressure). It should be noted that some runs experienced a pressure in the treatment chamber lower than atmospheric due to the simultaneous effect of feed pump (pushing) and impeller speed (pulling). Higher pressure (up to 3 times) could have been tested by reversing the direction of rotation of the impeller located in this treatment chamber. Given the results reported below, a higher pressure up to 10 bar would have resulted in a further increase of the process performance.

In total, 84 runs were conducted. As response variable, residual (dissolved) ozone was defined after uploading the all the runs in a statistical software package (Design Expert, Stat-Ease Inc., Minneapolis, USA). The data analysis workflow comprised: (1) data loading, (2) model selection, (3) ANOVA test, (4) quality assessment, (5) graphs generation. The data loading in the Design-Expert software comprised inputting the 84 runs conducted under the conditions specified in material and methods and in declaring the factors and the response to be analyzed. The model selection comprised comparing the ability of various models available in the software library to predict the response using the corresponding factors varied in the experiment. Specifically, the software produced a table summarizing the goodness of fitting for the following model types: linear, two-factor interaction, quadratic, cubic and quartic. The model suitability was evaluated according to the following parameters: (1) model p-value, (2) lack of fit p-value, (3) adjusted R-square and (4) predicted R-square. Based on these four parameters, the software provided recommendation to ensure the statistically soundness of the model selected. Furthermore, the selected model was subjected to further statistical screening for each of the model factors. This was accomplished by performing an additional statistical test consisting in selecting and deselecting each of the model term and performing a fitness test of the resulting equation using the adjusted-R-square calculation as criterion. More information on the mathematical approach used by the Design-Expert software can be found in the software manual.

Once the model structure was finally selected, each of the terms included in the model were assessed against their significance using an ANOVA test conducted on the response variable measured during the experiments (in our case, dissolved ozone). Specifically, the software produced an ANOVA table indicating, for each term, the sum of squares, the degree of freedom, the mean square, the F-value, and the p-value. The p-value was used to judge the significance of each term included in the model, at a p-threshold selected by the user. In this experiment, the p-threshold was set at 0.1. The output produced by Design-Expert comprised the following: (a) model diagnostics and tables, including normal probability plot of the model residues; residuals versus predicted and predicted versus observed plots; (b) one-factor-at-a-time plots for all factors included in the model; (c) two-factor-at-a-time response surfaces plots.

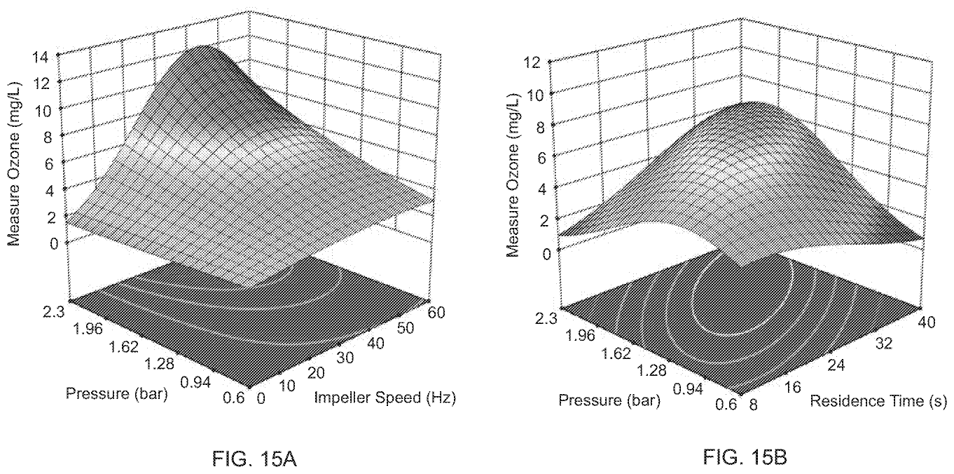

Referring to FIG. 15A to FIG. 15B, impeller speed in the treatment chamber and ozone mass rate were found highly statistically significant based on the ANOVA test conducted on the entire set of runs collected under Example 1. Further, it was unexpected that residence time and pressure in the treatment chamber were also highly statistically significant when considered in conjunction with other factors, for example: impeller speed with pressure; ozone mass rate with residence time; and residence time with pressure. Therefore, the process can be operated by tuning the significant factors involved in a way that the positive effect associated with the factors interactions is maximized.

The impeller speed plays a very significant role in enhancing gas-liquid mass transfer (FIG. 15A). All the other factors included in the model (residence time, ozone gas mass rate) were kept constant and equal to their average value tested in Example 1. FIG. 15A clearly shows that changing the speed from 0 to 60 Hz (0 to 3,600 rpm) improves the ozone dissolution efficiency, hence the mass transfer efficiency, by over 400%. Indeed, the residual ozone concentration at 0 Hz was roughly 2 mg/L and increased to over 8 mg/L when the impeller speed was increased to 60 Hz. FIG. 15A also shows that the greatest improvement is achieved when the impeller speed is controlled to a value greater than 30 Hz (1, 800 rpm), with a range of 40-55 Hz (2,400-3,300 rpm) showing the greatest improvement.

Further, the residence time required to achieve high ozone mass transfer was remarkably low, the residence time applied never exceeding 100 seconds, and even never exceeding 40 second. As shown in FIG. 15B, the mass transfer was nearly complete at residence times as low as 35 seconds. This time is substantially lower than any other commercially available ozonation process or methods known to us, which typically employ residence times exceeding 300 seconds (or 5 minutes). Being able to achieve a nearly complete mass transfer in less than 300 seconds is a highly beneficial feature of the process.

As shown in FIG. 15B, the pressure, in combination with the average mixing condition given by the impeller speed set at 30 Hz, played a very important role in establishing even higher mass transfer rates. Indeed, the dissolved ozone increased from 1.9 mg/L to 5.9 mg/L (all the other conditions being the same) when the pressure was increased from 0.7 bar to 2.3 bar, respectively, in the treatment chamber. Based on the solubility of ozone in water as a function of pressure, it is expected that the beneficial effect of pressure in dissolving ozone would continue up to 10 bars. Increasing the pressure could also allow a further reduction of the mixing intensity (controlled by the impeller speed) and the residence time (controlled by the system flowrate) required to achieve complete treatment of the contaminated fluid.

### Example 2: Use of Two Degradation Reagents in the Process

This example is directed to determining how the process performs when two reagents (ozone (O₃) and hydrogen peroxide (H₂O₂)) with known reaction stoichiometry and hydroxyl radical production yields are used, and whether the process would result in a consumption of dissolved ozone and hydrogen peroxide approaching a molar ratio of 2 between ozone and hydrogen peroxide, which is the optimal condition based on the stoichiometry of the reaction in Eq. 4: 2O₃+H₂O₂=2OH+3O₂ (Eq. 4).

Ozone and hydrogen peroxide were dosed in different molar ratio and process conditions. Process factors: (a) impeller speed; (b) ozone mass transfer and (c) residence time of the fluid in the treatment chamber, were varied. Hydrogen peroxide concentration was kept constant at a value ranging from 9-10 mg/L. The actual hydrogen peroxide concentration (initial and final) in the fluid stream was measured before and after adding hydrogen peroxide. Residual ozone (without the addition of hydrogen peroxide) was also predicted based on the results modelled in Example 1, which were carried out under nearly identical water quality conditions. The injection pressure of the reagent (e.g., ozone gas, comprising a mixture of oxygen and ozone gases) was kept constant at 3 bar for all the runs. In this way, a reagent pressure greater than or equal to pressure of the treatment chamber was achieved in all tests.

The following factors were systematically varied: (a) mixing conditions in the treatment chamber established by setting the impeller speed at a desired rotation frequency; (b) flowrate/residence time in the treatment chamber; (c) flowrate/pressure established in the treatment chamber by the first pump located immediately upstream the treatment chamber; (d) mass ratio between ozone and hydrogen peroxide, established in each run by controlling the ozone gas concentration injected between the pump and the treatment chamber and keeping the hydrogen peroxide concentration at approximatively 9-10 mg/L.

In total, 21 runs were conducted. As response variable, residual (dissolved) hydrogen peroxide concentration was experimentally measured. Using the statistical software package (Design Expert, Stat-Ease Inc., Minneapolis, USA), it was possible to build a response surface for the mass ratio of ozone divided by hydrogen peroxide. This calculation was carried out by estimating the incremental consumption of ozone caused by hydrogen peroxide. This number was divided by the experimentally observed consumption of hydrogen peroxide. By adjusting for molecular weight of the two chemicals, an ideal process would approach, under optimal process conditions, a mass ratio of ozone to hydrogen peroxide equal to 2×48/34=2.8. Essentially, for every mg of hydrogen peroxide dosed, 2.8 mg of ozone would disappear from the system and be converted to hydroxyl radicals.

The data analysis workflow comprised the following steps: (1) data loading, (2) model selection, (3) ANOVA test, (4) model quality assessment, and (5) graph generation. The data loading in the Design-Expert software comprised inputting the 21 runs conducted under the conditions specified in material and methods and in declaring the factors and the response to be analyzed. Using the statistical model, it was possible to optimize the process by requesting the maximization of the ozone: hydrogen peroxide mass ratio response variable while keeping the other parameters unconstrained. The optimal parameter ranges for the production of hydroxyl radicals from the reaction between ozone and hydrogen peroxide are: Impeller speed=20 to 60 Hz; Ozone mass rate=45 to 160 g/hr; Residence time=1 to 36 sec. Under those conditions, peroxide reaction efficiency ranging from 65.5% to 110% has been observed. These results are obtained for a process operated between 0.6 and 3 bar of absolute pressure in the treatment chamber.

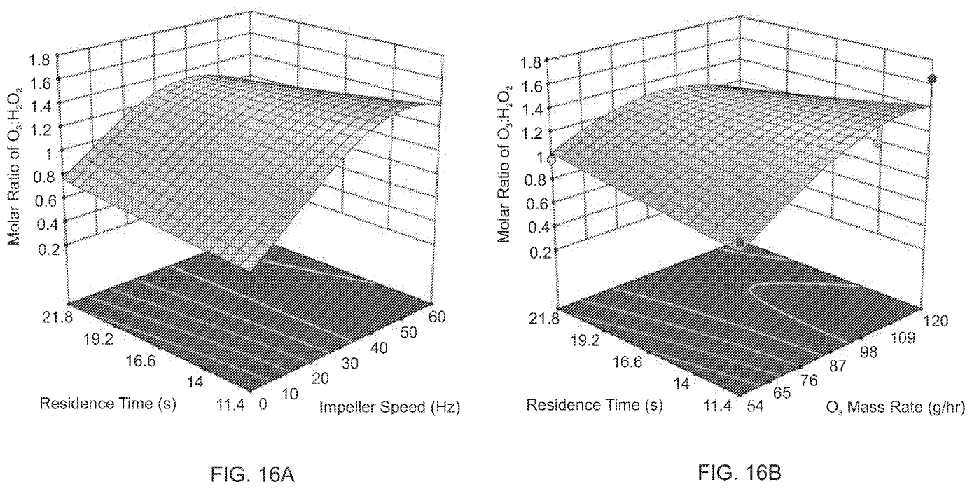

Referring to Table 1 and FIG. 16A and FIG. 16B, there are process conditions when the molar ratio of reacted ozone and reacted peroxide (R_O₃_H₂O₂) approaches the stochiometric value of 2. There is one condition (Run 19) where it gets as close as 1.97. This corresponds to a reaction efficiency essentially equal to 100%.

The most significant process parameters for establishing high reaction efficiency between ozone and hydrogen peroxide are: (a) impeller speed and ozone mass injection rate. While residence time alone is not a significant parameter, residence time becomes very significant if considered in combination with impeller speed and ozone injection rate. These significant two-factor interactions highlight the industrial relevance of the process.

TABLE 1

| | | | O₃ | Resi- | Mole | Mole | |
|---|---|---|---|---|---|---|---|
| | Pump | Flow | Mass | dence | O₃ | H₂O₂ | |
| Run | Speed | Rate | Rate | Time | Reacted | Reacted | R_O₃_H₂O₂ |
| - | Hz | L/min | g/hr | sec | mol/L | mol/L | molar basis |
| 1 | 0 | 55 | 120 | 21.8 | 0.040 | 0.277 | 0.14 |
| 2 | 0 | 55 | 100 | 21.8 | 0.039 | 0.048 | 0.82 |
| 3 | 0 | 55 | 80 | 21.8 | 0.036 | 0.042 | 0.85 |
| 4 | 0 | 55 | 54 | 21.8 | 0.027 | 0.051 | 0.53 |
| 5 | 30 | 55 | 120 | 21.8 | 0.156 | 0.155 | 1.01 |
| 8 | 30 | 55 | 54 | 21.8 | 0.108 | 0.110 | 0.98 |
| 9 | 60 | 55 | 120 | 21.8 | 0.160 | 0.146 | 1.10 |
| 10 | 60 | 55 | 100 | 21.8 | 0.158 | 0.155 | 1.02 |
| 11 | 60 | 55 | 80 | 21.8 | 0.143 | 0.140 | 1.03 |
| 12 | 60 | 55 | 54 | 21.8 | 0.110 | 0.106 | 1.04 |
| 13 | 0 | 105 | 120 | 11.4 | 0.049 | 0.075 | 0.65 |
| 14 | 0 | 105 | 100 | 11.4 | 0.043 | 0.007 | n/a |
| 16 | 0 | 105 | 54 | 11.4 | 0.023 | 0.063 | 0.36 |
| 17 | 30 | 105 | 120 | 11.4 | 0.126 | 0.076 | 1.65 |
| 18 | 30 | 105 | 100 | 11.4 | 0.111 | 0.088 | 1.27 |
| 19 | 30 | 105 | 80 | 11.4 | 0.090 | 0.046 | 1.97 |
| 20 | 30 | 105 | 54 | 11.4 | 0.060 | 0.068 | 0.88 |
| 21 | 60 | 105 | 120 | 11.4 | 0.132 | 0.089 | 1.48 |
| 22 | 60 | 105 | 100 | 11.4 | 0.116 | 0.086 | 1.36 |
| 23 | 60 | 105 | 80 | 11.4 | 0.094 | 0.064 | 1.46 |
| 24 | 60 | 105 | 54 | 11.4 | 0.062 | 0.077 | 0.80 |

### Example 3: Application of the Process to Pollutants

This example is directed to determining the efficacy of the process against real micropollutants and other conventional pollutants. Both spike and non-spike tests were conducted. Spike tests were carried out in two different water matrices (dechlorinated GAC-treated tap water, spiked with nitrite NO₂⁻ and TOC to modify the background oxidant and radical demands). in this example, the process intensifies degradation of pollutants by increasing pressure and mixing (simultaneously applied) leading to substantially accelerated kinetics. As a result, treatment dose (i.e., concentration·time (CT) dose) required to achieve pollutant degradation is significantly lower than those used in conventional technology.

The same process as described above, conducted with different oxidants (both alone and in combination), was tested in real tertiary treated wastewater. In this case, GAC-filtered secondary effluent obtained from a municipal wastewater treatment plant was used. The pollutants tracked during the study were already present in the influent wastewater stream. The process was experimentally and numerically optimized in terms of type and quantity reagents used, by implementing in the treatment system four different combination of reagents: (a) ozone alone; (b) ozone with hydrogen peroxide; (c) ozone with sodium hypochlorite (NaClO); (d) sodium hypochlorite alone. This study was also aimed at identifying suitable surrogates for advanced process control; hence, during the experimental runs, for each testing conditions, the effluent values for absorbance at nm were measured together with the residual values of the added reagents such as ozone, hydrogen peroxide and sodium hypochlorite. Correlations between these optical parameters, process conditions, and micropollutants, were developed to validate the possibility of using surrogate parameters for the control of the disclosed process.

Advanced oxidation and reduction processes are known to be effective against micropollutants and other contaminants present in water and wastewater. Prior studies have indicated that minimum CT requirements must be met to achieve desired removal rates. Such CT requirements are dependent on the type of contaminants being removed and the water matrix. Typical concentration and contact times for the ozonation process operated in conventional technologies, targeting micropollutant oxidation, are reported to range between 1-10 mg/L for initial ozone concentration and 10-30 min as contact time. Combining these values would result in a CT dose ranging from 10 to 300 mg/L min. in the process described herein, high intensification rate produced by high pressure and high mixing, results in optimal performance but at much shorter CT doses. The following example tests the process under a variety of CT values ranging from 0 to 10 mg/L per min (for the case of spiked micropollutants) and 0-1 mg/L min (for the case of indigenous micropollutants in wastewater).

The following parameters were systematically varied: (a) mixing conditions in the treatment chamber established by setting the impeller speed at a desired rotation frequency; (b) flowrate/residence time in the treatment chamber; (c) flowrate/pressure established in the treatment chamber by the first pump located immediately upstream the treatment chamber; and (d) ozone mass rate injected in the system. In total, 54 runs were conducted for the spiked study and 25 runs were conducted for the wastewater study. The spiked study was conducted for two wastewater qualities, denominated “high” and “low”. The high quality was obtained by GAC-filtered dechlorinated tap water, while the low quality was the same water spiked with 5 mg/L of nitrite and 10 mg/L of TOC (using methanol). Collected data were analyzed using the statistical software package (Design Expert, Stat-Ease Inc., Minneapolis, USA). The data analysis workflow comprised: (1) data loading, (2) model selection, (3) ANOVA test, (4) model quality assessment, and (5) graph generation. The data loading in the Design-Expert software comprised inputting the 54 runs conducted under the conditions specified in material and methods and in declaring the parameters and the response to be analyzed. Similarly, a Design-Expert file was created with the 25 runs operated with real wastewater.

An optimization simulation was conducted for the spiked studies as well as for the wastewater studies. The optimizer was set to maximize removal efficiency of pBCA as well as all the other micropollutants spiked in the water, while keeping the other parameters within their tested range. Table 2 shows the first 10 most optimal combinations for the spiked study. There are several combinations where CT (in mg/L min) is less than 7. A similar optimization study was repeated for the wastewater study, with the objective of maximizing PFOA removal, and the results are shown in Table 3. Using the influent (Inf) data, the most optimal condition reported in Table 3 was able to achieve the following removal efficiencies: COD abatement=578, Absorbance at 254 nm=52%, PFHxA=56%, PFOA=14%, THM=not formed relative to the influent baseline. PFHxA is perfluorohexanoic acid. PFOA is perfluorooctanoic acid. THM is trihalomethane.

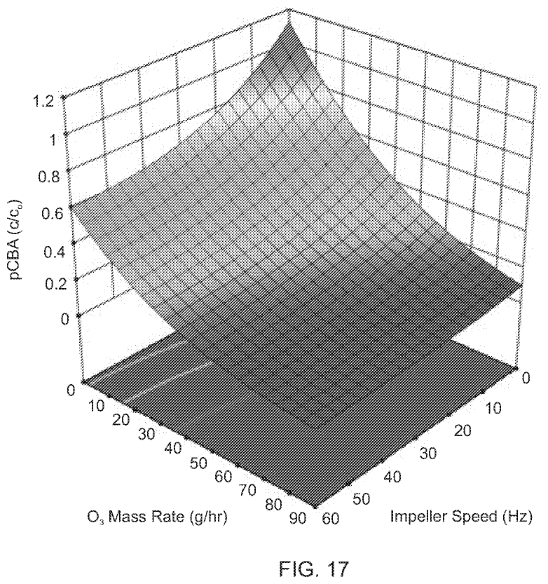

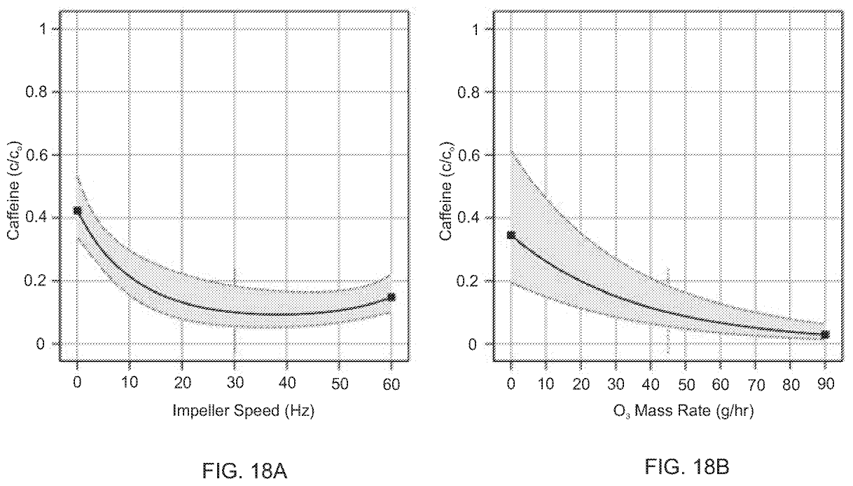

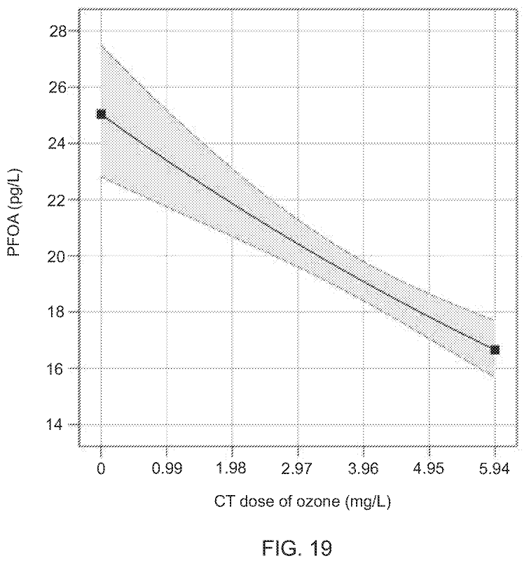

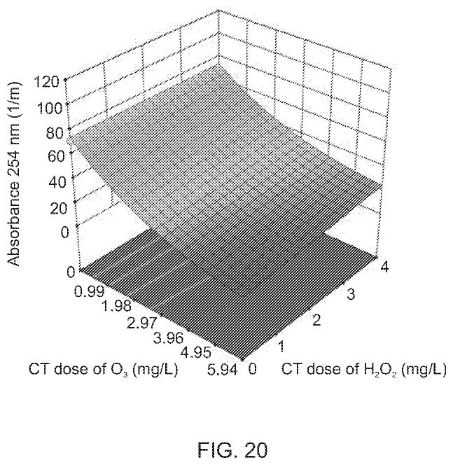

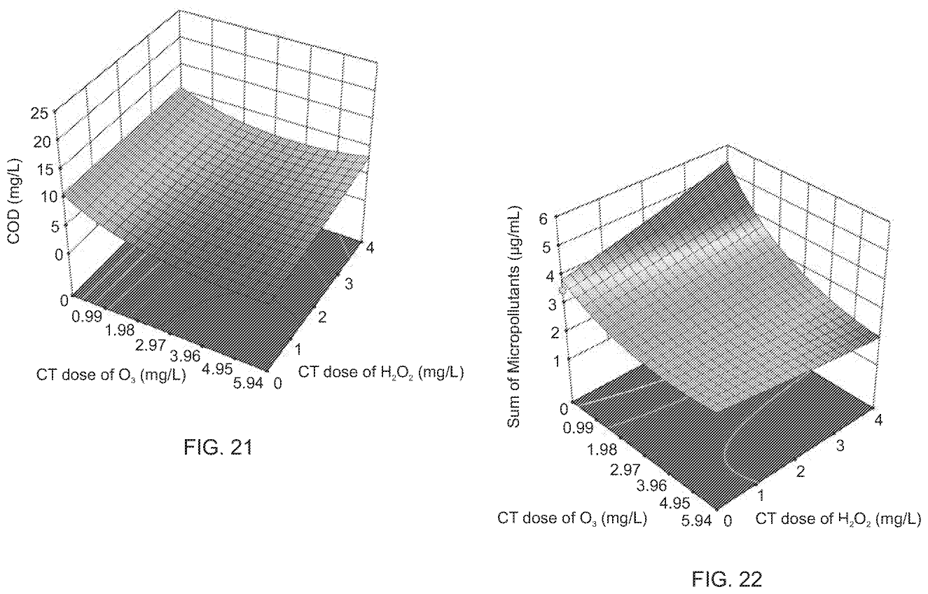

With reference to Table 2, Table 3 and FIG. 17 to FIG. 22, spiked experiments confirmed the superior performance of the tested process, implemented under high pressure, high mixing and short residence time. The CT dose required for removing micropollutants from the fluid was less than 10 mg/L·min. Outstanding process performance was obtained with tertiary treated wastewater, in which case the tested CT values were all less than 1 mg/L·min. Nonetheless, the removal of indigenous micropollutants was, under optimized conditions, greater than 80%. Such high removal performance at such low CT doses is unprecedented. Dosages of ozone greater than 6 mg/L and hydrogen peroxide greater than 4 mg/L led to the removal of per- and polyfluoroalkyl substances (PFAS) compounds, confirming that advanced reduction pathways enabled by the process conditions tested can de-fluorinate long chain PFAS very rapidly and cost effectively.

TABLE 2

| | Pump | 03 Mass | Pres- | Methylene | | Caf- | Carba- |
|---|---|---|---|---|---|---|---|
| Run | Speed | Rate | sure | Blue | pCBA | feine | mazepine |
| - | Hz | g/hr | bar | C/C_{°} | C/C_{°} | C/C_{°}) | C/C_{°} |
| 1 | 60 | 54 | 1.52 | 0.036 | 0.12 | 0.111 | 0.037 |
| 2 | 43.862 | 47.507 | 1.701 | 0.017 | 0.15 | 0.089 | 0.038 |
| 3 | 44.636 | 51.795 | 1.414 | 0.035 | 0.15 | 0.079 | 0.028 |
| 4 | 52.796 | 54.422 | 1.156 | 0.062 | 0.14 | 0.085 | 0.026 |
| 5 | 39.37 | 57.638 | 1.406 | 0.026 | 0.13 | 0.064 | 0.022 |
| 6 | 53.223 | 47.423 | 1.246 | 0.077 | 0.17 | 0.107 | 0.039 |
| 7 | 49.149 | 63.967 | 1.754 | 0.005 | 0.08 | 0.058 | 0.017 |
| 8 | 49.69 | 48.281 | 1.061 | 0.077 | 0.18 | 0.095 | 0.033 |
| 9 | 23.084 | 54.3 | 1.754 | 0.016 | 0.16 | 0.093 | 0.049 |
| 10 | 42.146 | 43.71 | 1.155 | 0.072 | 0.21 | 0.098 | 0.039 |

TABLE 3

| | | | | | Abs_ | | | |
|---|---|---|---|---|---|---|---|---|
| Run | O₃ | H₂O₂ | NaClO | COD | 254 | PFHxA | PFOA | THM |
| - | mg/L | mg/L | mg /L | mg/L | 1/m | pg/L | pg/L | ug/L |
| 1 | 5.796 | 0.948 | 0.272 | 8.764 | 19.713 | 11.714 | 18.158 | 1.281 |
| 2 | 5.94 | 0 | 0 | 8.68 | 18.923 | 12.56 | 19.387 | 1.094 |
| 3 | 5 | 0 | 0 | 8.575 | 20.298 | 13.962 | 19.795 | 1.01 |
| 4 | 4.04 | 0 | 0 | 9.002 | 22.194 | 15.394 | 20.221 | 0.959 |
| 5 | 5.064 | 1.018 | 1.198 | 6.022 | 20.325 | 12.727 | 18.682 | 1.965 |
| 6 | 5.69 | 0.077 | 1.851 | 4.53 | 18.665 | 12.847 | 19.39 | 2.385 |
| 7 | 5.149 | 0.078 | 1.58 | 4.768 | 19.417 | 13.652 | 19.641 | 2.243 |
| 8 | 2.99 | 0 | 0 | 10.189 | 24.977 | 16.96 | 20.697 | 0.939 |
| 9 | 4.199 | 0.339 | 0.957 | 6.107 | 21.446 | 14.777 | 19.909 | 1.764 |
| 10 | 5.485 | 2.447 | 1.148 | 7.664 | 20.855 | 10.498 | 16.694 | 1.938 |
| Inf | 0 | 0 | 0 | 21 | 38.8 | 25.77 | 21.35 | 1.00 |

Additional tests were carried out to verify the novelty and non-obviousness of the new method and system disclosed herein, which uses an oxidant as a reagent (i.e., sodium hypochlorite). Specifically, we evaluated the performance of the current method and system by conducting the following experiment: first, a reagent (i.e., sodium hypochlorite) was dosed at a given concentration and contact time using the method and system for treating a fluid stream as described herein. Secondly, the same experiment with identical concentration and contact time was carried out using a conventional magnetic stirrer (intended to mimic conventional mixing systems operating at mixing intensity values not exceeding 0.25 W/L). As a matter of fact, it should be noted that the novel method and system were operated at a mixing intensity value >0.7 W/L, while the control experiment (with the conventional magnetic stirrer) was operated at a mixing intensity value typical of <0.25 W/L, representing the higher end value for mixing intensities applied in full-scale wastewater treatment plants. It should also be mentioned operating at high mixing intensity provides a means to deliver high G*t values (where G*t is a dimensionless number used in coagulation/flocculation studies obtained by multiplying the velocity gradient G in seconds-1 times mixing time in seconds). Therefore, the novel method and system disclosed herein is also characterized for being able to operate, for a given mixing time, at much higher G*t values than conventional processes, since G*t can be expressed as G (s⁻¹)*t (s−1)=(P/(n*V)) \hat{ }0.5*t, where P is the power input (W), n is the dynamic viscosity (Pas) of the fluid stream, and V is the volume (m³) of the treatment chamber in which the power input is applied, and t is the mixing time (sec). All remaining process parameters used in the side-by-side experiments, including chemical reagent dose (i.e., initial sodium hypochlorite concentration) and contact time (i.e., the time used to contact the contaminated fluid with sodium hypochlorite), were kept identical.

Upon completion, the water quality parameter measured in the treated water to compare the efficacy of the innovative method and system against the prior art (represented by the conventional magnetically stirred batch experiment) was total residual chlorine. From total residual chlorine, it was possible to estimate a key quantity to assess process reactivity: the reacted total chlorine (or sodium hypochlorite). This is the difference between the initial sodium hypochlorite (spiked in the experiment based on the initial sodium hypochlorite stock concentration) and the residual total chlorine (or sodium hypochlorite) measured at the end of the experiment.

Results clearly indicated that when sodium hypochlorite was dosed with the novel method and system disclosed in this document, the reacted reagent (the difference between the amount of hypochlorite dosed in the water and the amount measured after the designed contact time) was considerably higher than in the control experiment (i.e., magnetically stirred operated under identical process conditions but at a m intensity <0.25 W/L). More specifically, when 5 mg/L of initial hypochlorite concentration was spiked in both systems and kept for the same contact time, the effluent treated by the novel method and had 2.5 mg/L system of residual hypochlorite concentration, while 4 mg/L was detected in the magnetically stirred batch system. Similarly, when 16 mg/L was spiked as initial sodium hypochlorite concentration and kept for the same contact time in both systems operating at different mixing intensities, the effluent produced using the novel method and system (operated at mixing intensity >0.7 W/L) had 5 mg/L of residual hypochlorite, while 12 mg/L was detected in the magnetically stirred batch system. Converted to reacted chlorine (or sodium hypochlorite), the values observed for the novel method and system described herein were vastly higher (i.e., 2.5 mg/L versus 1 mg/L in the first experiment, and 11 mg/L versus 4 mg/L in the second experiment, respectively). This much higher reactivity recorded for the method and system reported herein (operated at mixing intensity >0.7 W/L) attests to the production of reactive species at a much larger concentration than prior art methods and systems operating at mixing intensity <0.25 W/L.

To further confirm this, a final experiment was carried out by comparing the reactivity of a method and system operated with a single pump (representing improvements potentially attainable by a person with average skills in the state of the art) versus a method and system operated according to the description of the invention reported in the e present disclosure. This experiment was conducted by injecting the same amount of chemical, for the same contact time, into either the first method and system or the second. The chlorine stock concentration and the water used in the test were the same. Results confirmed that the reactivity of sodium hypochlorite was much higher when the reagent (i.e., sodium hypochlorite) was injected into the system configured according to this disclosure (i.e., using one or more pumps in series operated at mixing intensity >0.7 W/L, with reagent released in the high-pressure/high-mixing-intensity zone generated by the method and system disclosed herein). Remarkably, no significant differences were observed when the results obtained by a single pump were compared to those obtained with the magnetically stirred system. This confirms that the simultaneous use of high mixing intensity (>0.7 W/L) and pressure (>0.1 bar above atmospheric pressure) are the enabling conditions of this invention. On the contrary, when two or more pumps in series were used to mimic the method and system disclosed in the current invention (i.e., a process operated at mixing intensity >0.7 W/L with pressure >0.1 above atmospheric pressure), the reacted sodium hypochlorite was remarkably higher, confirming the important role played by mixing intensity, pressure, and other thermodynamic and physicochemical conditions established with the novel method and system described in this invention.

The unique process conditions established in the disclosed method and system are substantially different from those reported in the state of the art. This can be better exemplified with the following calculations. Consider the well-known mixing parameter reported in water treatment textbooks and widely used for optimizing mixing conditions in various treatment processes, i.e., the G parameter (also known as velocity gradient, measured in s⁻¹). It should be noted that the G parameter is mathematically linked to mixing intensity (defined in our invention as mixing power input per volume) by the following relation: G (s⁻¹)=(P/(n*V))\hat{ }0.5, where P is the power input (W), n is the dynamic viscosity (Pa·s) of the fluid stream, and V is the volume (m³) of the treatment chamber in which the power input is applied. By rearranging the above equation, it is possible to derive a mathematical relation connecting velocity gradient (G, s⁻¹) and mixing intensity (P/V) as defined in this disclosure. Upon rearranging it, we obtain: P/V=G²*n, with P/V having the unit of W/m³.

Considering the G values typically encountered in water treatment textbooks for process conditions with the highest G requirements (i.e., rapid mixers), values in the range of 300-500 s⁻¹ are found. Using a value for dynamic viscosity of 10⁻³ Pa·s (typical for water), the higher mixing intensity values associated with rapid mixing applications can be calculated to be in the range of 90-250 W/m³ (or 0.09-0.25 W/L). It should also be mentioned that these conditions are typically applied at nearly atmospheric pressure and/or for very short contact times <10 seconds. Increasing, maintaining, and controlling conditions in a treatment chamber sufficient to simultaneously achieve high mixing intensity (>0.25 W/L) and high pressure (>0.1 bar above atmospheric) for a contact time sufficient not only to achieve mixing but also to degrade a contaminant in a fluid stream is another distinctive feature of the method and system disclosed in the current invention. Hence, the exceptionally remarkable results in terms of fluid reactivity and production of reactive species observed in the experiment can undoubtedly be attributed to the use of very high mixing intensity (>700 W/m³ or 0.7 W/L), certainly much higher than those commonly applied in prior art (i.e., 90-250 W/m³ or 0.09-0.25 W/L). Finally, it should also be noted that such values reported for the state of the art are typically applied in coagulation/flocculation applications, while our current invention is preferentially focused on optimized process conditions for achieving degradation; specifically, but not limited to, conditions required to achieve high-rate disinfection, oxidation, and reduction of a contaminated fluid stream. For those applications, the mixing intensity applied in prior art is even lower than those reported above for coagulation and flocculation processes, not exceeding 100 W/m³ or 0.1 W/L.

The method and system reported in this disclosure can be further configured as a flow chemistry process and apparatus to produce a desired compound in a liquid stream. The method and system can be operated either in line with the main fluid stream or side stream. In the latter configuration, the desired compound can be either dosed in the main fluid stream in real-time or stored and subsequently dosed. Without limitation, examples of the production of such compounds or classes of compounds include: (a) pharmaceutical ingredients; fine chemicals; agrochemicals; energetic materials; specialty chemicals; flavors and fragrances; dyes and pigments; nanomaterials; quantum dots.

The novel features will become apparent to those of skill in the art upon examination of the description. It should be understood, however, that the scope of the claims should not be limited by the embodiments but should be given the broadest interpretation consistent with the wording of the claims and the specification as a whole.

1.-42. (canceled)

43. A process for the degradation of a chemical compound in a liquid stream, the process comprising:
providing a pump fluidically connected in series with a treatment chamber comprising a mixer, and a reagent injector between the pump and the treatment chamber;
introducing the liquid stream to an inlet of the pump;
operating the pump to direct the liquid stream to an inlet of the treatment chamber to produce a pressure increase between the pump inlet and the treatment chamber of from 0.1 bar to 10 bar;
introducing a degradation reagent into the liquid stream through the injector at a pressure greater than or equal to the pressure between the pump inlet and the treatment chamber; and
operating the mixer to mix the degradation reagent in the liquid stream at a mixing intensity, namely a mixing power input per volume, wherein the mixing power input is the power of the mixer and the volume is the volume of the treatment chamber, in a range of from 0.7 W/L to 700 W/L to intentionally create physical and chemical conditions required to simultaneously enhance the mass transfer and the degradation of one or more contaminants present in the liquid stream.

44. The process of claim 43, wherein the liquid stream is a water stream.

45. The process of claim 43, wherein the degradation reagent is gaseous.

46. The process of claim 43, wherein the degradation reagent comprises ozone.

47. The process of claim 43, wherein the liquid stream has a residence time between the pump inlet and an outlet of the treatment chamber in a range of from 0.1 second to 100 seconds.

48. The process of claim 43, further comprising introducing hydrogen peroxide into the liquid stream before introducing the liquid stream to the inlet of the pump.

49. The process of claim 43, further comprising providing a valve downstream of the treatment chamber and operating the valve to control the pressure between the pump inlet and the treatment chamber.

50. The process of claim 43, further comprising exposing the liquid stream to ultraviolet light downstream of the treatment chamber.

51. The process of claim 43, wherein the pump is a first pump and the mixer comprises a second pump.

52. The process of claim 43, wherein the degradation reagent is selected from the group consisting of chlorine, chlorine dioxide, performic acid, and peracetic acid.

53. The process of claim 43, wherein the mixing intensity is automatically adjusted based on real-time monitoring of a parameter selected from pH, oxidation-reduction potential, wall shear, vibrational noise, flow velocity or turbidity of the liquid stream.

54. A system for conducting a process for degradation of a chemical compound in a liquid stream according to claim 43, the system comprising:
an inlet for receiving the liquid stream;
a pressure increase zone fluidically connected to the inlet;
a fluid moving device for propelling the liquid stream into a treatment chamber to produce a pressure increase between 0.1 bar to 10 bar;
a plurality of degradation reagent injection zones for injecting degradation reagents into the liquid stream;
a centrifugal mixer for mixing the degradation reagents with the liquid stream in the treatment chamber, wherein the treated liquid flows out of the treatment chamber through an outlet, the mixer being designed to be operated to mix the degradation reagent in the liquid stream at a mixing intensity, namely a mixing power input per volume, wherein the mixing power input is the power of the mixer and the volume is the volume of the treatment chamber, in a range of from 0.7 W/L to 700 W/L to intentionally create physical and chemical conditions required to simultaneously enhance the mass transfer and the degradation of one or more contaminants present in the liquid stream.

55. The system of claim 54, further comprising:
an extension chamber inserted between the first degradation reagent injection zone and the second degradation reagent injection zone for extending the path length of the treatment chamber; and
wherein the fluid moving device comprises a pump that has an impeller that is co-rotated with the centrifugal mixer in a rotational direction, thereby providing for greater residence time of the liquid stream in the treatment chamber.

56. The system of claim 55, wherein the fluid moving device has an impeller that is counter-rotated with the centrifugal mixer, such that the impeller rotates in one rotational direction and the centrifugal mixer rotates in a different rotational direction, thereby providing for different mixing mechanics for the liquid stream in the treatment chamber.

57. The system of claim 54, wherein the first degradation reagent injection zone is situated upstream of the inlet, thereby providing for greater residence time of the first degradation reagent in the liquid stream without increasing the residence time of the liquid stream in the treatment chamber.

58. The system of claim 54, wherein the first degradation reagent injection zone comprises two ports for simultaneous injection of both the first degradation reagent and a third degradation reagent, and the second degradation reagent injection zone comprises two ports for simultaneous injection of both the second degradation reagent and a fourth degradation reagent, thereby permitting injection of more than two degradation reagents into the liquid stream.

59. The system of claim 54, further comprising:
a third degradation reagent injection zone situated upstream of the inlet and a fourth degradation reagent injection zone situated downstream of the outlet, wherein a third degradation reagent is injected into the liquid stream in the third degradation reagent injection zone and a fourth degradation reagent is injected into the treated liquid stream in the fourth degradation reagent injection zone, thereby permitting injection of a degradation reagent into the treated liquid stream for further treatment of the liquid stream.

60. The system of claim 54, further comprising:
a post-treatment chamber inserted downstream of the outlet with a fourth degradation reagent injection zone inserted between the outlet and the post-treatment chamber for injecting a fourth degradation reagent into the treated liquid leaving the outlet, wherein the post-treatment chamber has its own post-treatment outlet downstream thereof and the system comprises a fifth degradation reagent injection zone downstream of post-treatment outlet for injecting a fifth degradation reagent as the treated liquid stream exits the system, thereby permitting further treatment of the liquid stream downstream of the mixing zone.

61. The system of claim 54, further comprising:
a post-treatment chamber inserted downstream of the outlet, wherein the post-treatment chamber is equipped with ultraviolet lamps for further treating the liquid in the post-treatment chamber, thereby permitting UV treatment of the liquid stream downstream of the mixing zone.

62. The system of claim 54, further comprising:
an extension chamber inserted between the first degradation reagent injection zone and the second degradation reagent injection zone, wherein the extension chamber is equipped with ultraviolet lamps for treating the liquid stream in the extension chamber, thereby permitting UV treatment of the liquid stream in the treatment chamber.

63. The system of claim 54, further comprising:
an extension chamber inserted between the first degradation reagent injection zone and the second degradation reagent injection zone, wherein the extension chamber is equipped with a filtration unit for treating the liquid stream in the extension chamber, thereby permitting filtration of the liquid stream in the treatment chamber.

64. The system of claim 54, further comprising:
a pressure regulator inserted between the mixing zone and the outlet, wherein the pressure regulator can be operated to help maintain a desired pressure in the treatment chamber, thereby providing a means for pressure control in the treatment chamber.
